(19) United States
(12) Patent Application Publication
(10) Pub. No.: US 2026/0080407 A1
(43) Pub. Date: Mar. 19, 2026

(54) METHOD AND SYSTEM FOR SEAMLESS CROSS-NETWORK PHYSICAL-DIGITAL (PHY-GITAL) EXPERIENCE

(71) Applicant: MASTERCARD ASIA/PACIFIC PTE. LTD., Singapore (SG)

(72) Inventors: Gerald NG, Singapore (SG); Shi Ler SHILA CHEW, Singapore (SG); Dendy GUNAWAN, Singapore (SG); Donghao HUANG, Singapore (SG)

(73) Assignee: MASTERCARD ASIA/PACIFIC PTE. LTD., Singapore (SG)

(21) Appl. No.: 18/889,521

(22) Filed: Sep. 19, 2024

(51) Int. Cl. G06Q 20/40; G06Q 20/32; G06Q 20/36; G06Q 20/38

(52) U.S. Cl. CPC G06Q 20/4014; G06Q 20/3278; G06Q 20/3674; G06Q 20/3825; G06Q 2220/00

(57) ABSTRACT

A method and system for cross-network transactions includes a processor for storing a blockchain having a non-fungible token (NFT) associated with a physical asset, the NFT having metadata including at least a product identifier and product details. The processor may store one or more user account profiles each including a user identifier and a blockchain wallet address. The processor may receive a product verification request message including a machine-readable code from a first user computing device, execute a query on the blockchain to identify an NFT including a product identifier matching the machine-readable code and in response to identifying an NFT including a product identifier matching the machine-readable code, determine the product associated with the machine-readable code is verified. The processor may generate a verification result indicating that the product associated with the machine-readable code is verified code and transmit the verification result to the first user computing device.

### FIELD

The present disclosure relates to cross-network transactions of goods associated with a corresponding digital asset. More particularly, the present disclosure relates to the transaction of goods embedded with a machine-readable chip that is associated with a digital asset stored on a blockchain.

### BACKGROUND

Ensuring the authenticity of goods being sold in the marketplace has always been an important factor for manufacturers, distributors, merchants, and consumers alike. With the increasing proliferation of e-commerce and the secondary market commerce of goods, ensuring the authenticity of goods being sold in the marketplace has become more important than ever. One solution for ensuring the authenticity of goods sold in the marketplace today is the creation of a digital asset representing the good, e.g., a digital twin, that can be tracked over time as the good is transacted between various parties, e.g., from manufacturer to distributor, from distributor to retailer, from retailer to consumer, from consumer to consumer, etc. A digital twin can be in the form of a digital token, e.g., a non-fungible token (NFT), and can be tracked using a blockchain. Today, we often see that after the minting of a digital twin, e.g., a NFT, of a physical asset, there is a decoupling of the physical asset and the digital twin, e.g., the digital twin is not physically coupled/attached to the physical asset. This decoupling or separation causes friction as it disrupts users from enjoying a true physical-digital, “phy-gital,” experience. A digital twin cannot function as a direct substitute for the physical asset and when the digital twin is decoupled from the physical asset, it could be traded away on a marketplace without/separate from the physical asset. Therefore, currently, it is difficult to prove the authenticity of both the physical and digital goods, especially in e-commerce or on the secondary market, without requiring the help of a third-party for proof of authenticity. Further, because of the decoupling of the physical asset and its digital twin, most brands today are unable to generate revenue from secondary sales despite a booming pre-loved, i.e., secondary, market. In addition, the transfer of a digital twin, e.g., NFT, ownership is often a cumbersome process, specifically for users foreign to web3 technology. Therefore, there is a need for a novel and innovative solution where a physical asset and digital twin can be suitably linked so as to provide value to both end-users, e.g., consumers, and brands, e.g., merchants.

### SUMMARY

A method for cross-network transactions, the method including: storing, in a memory of a processing server, a blockchain comprised of a plurality of blocks, each block of the plurality of blocks including at least a block header and one or more data values, wherein each data value of the one or more data values is a non-fungible token (NFT) associated with a physical asset, and wherein each NFT includes metadata including at least a product identifier and product details; storing, in the memory of the processing server, a database, the database including one or more user account profiles, each of the one or more user account profiles including a user identifier and a blockchain wallet address; receiving, by a receiving device of the processing server from a first user computing device, a product verification request message including a machine-readable code; executing, by a querying module of a processing server, a query on the blockchain to identify an NFT including a product identifier matching the machine-readable code; in response to identifying an NFT including a product identifier matching the machine-readable code, determining, by a validation module of the processing server, the product associated with the machine-readable code is verified; generating, by a generation module of the processing server, a verification result indicating that the product associated with the machine-readable code is verified, the verification result including the product identifier and product details; and transmitting, by a transmitting device of the processing server, the verification result to the first user computing device.

A system for cross-network transactions, the system including: a first user computing device; and a processing server, the processing server configured to: store, in a memory of the processing server, a database, the database including one or more user account profiles, each of the one or more user account profiles including a user identifier and a blockchain wallet address; receive, by a receiving device of the processing server from a first user computing device, a product verification request message including a machine-readable code; execute, by a querying module of a processing server, a query on the blockchain to identify an NFT including a product identifier matching the machine-readable code; in response to identifying an NFT including a product identifier matching the machine-readable code, determine, by a validation module of the processing server, the product associated with the machine-readable code is verified; generate, by a generation module of the processing server, a verification result indicating that the product associated with the machine-readable code is verified, the verification result including the product identifier and product details; and transmit, by a transmitting device of the processing server, the verification result to the first user computing device.

19. A computer program product for cross-network transactions, the computer program product including a non-transitory computer-readable storage medium having program instructions embodied therewith, the program instructions executable by a computer to cause the computer to: store, in a memory, a blockchain comprised of a plurality of blocks, each block of the plurality of blocks including at least a block header and one or more data values, wherein each data value of the one or more data values is a non-fungible token (NFT) associated with a physical asset, and wherein each NFT includes metadata including at least a product identifier and product details; store, in the memory, a database, the database including one or more user account profiles, each of the one or more user account profiles including a user identifier and a blockchain wallet address; receive, by a receiving device from a first user computing device, a product verification request message including a machine-readable code; execute, by a querying module, a query on the blockchain to identify an NFT including a product identifier matching the machine-readable code; in response to identify an NFT including a product identifier matching the machine-readable code, determine, by a validation module, the product associated with the machine-readable code is verified; generate, by a generation module, a verification result indicating that the product associated with the machine-readable code is verified, the verification result including the product identifier and product details; and transmit, by a transmitting device, the verification result to the first user computing device.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for cross-network transactions in accordance with exemplary embodiments;

FIG. 2 is a block diagram illustrating the processing server in the system of FIG. 1 for cross-network transactions in accordance with exemplary embodiments;

FIG. 3A-3C are flow diagrams illustrating a process for cross-network transactions in the system of FIG. 1 in accordance with exemplary embodiments

FIGS. 4A-4C are flow diagrams illustrating a process for cross-network transactions in the system of FIG. 1 in accordance with exemplary embodiments;

FIGS. 5A-5B are flow diagrams illustrating a process for cross-network transactions in the system of FIG. 1 in accordance with exemplary embodiments;

FIGS. 6A-6D is a flow chart illustrating an exemplary method for cross-network transactions in accordance with exemplary embodiments; and

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

### System for Cross-Network Transactions

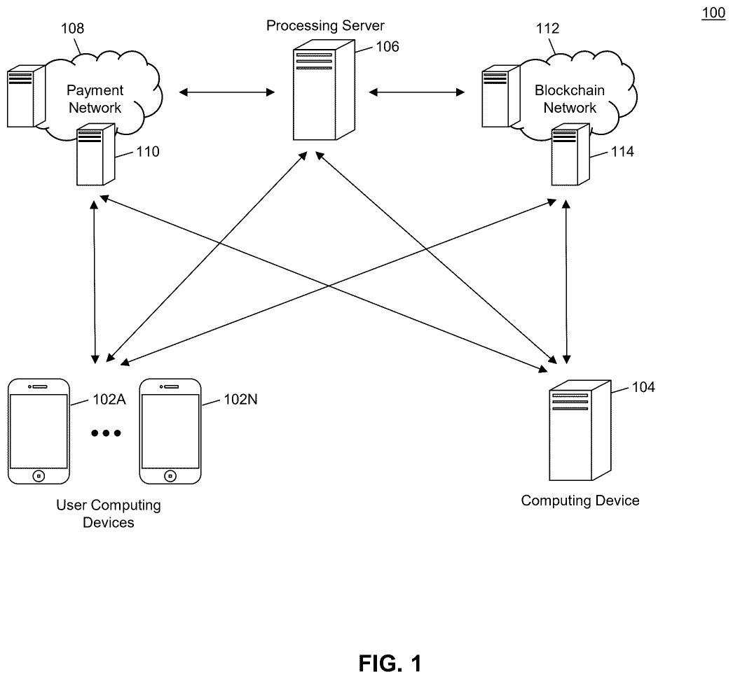

FIG. 1 illustrates a system 100 for cross-network transactions. The system 100 can include one or more user devices 102A-N, computing devices 104, processing server 106, payment network 108, and blockchain network 112.

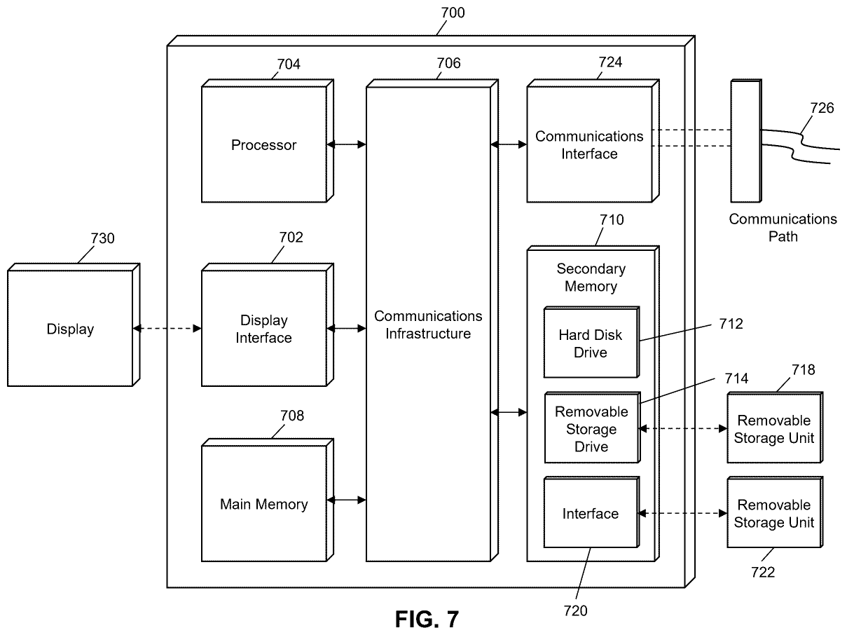

The user computing devices 102A-N may be a desktop computer, a notebook, a laptop computer, a tablet computer, a handheld device, a smart-phone, a thin client, a smartwatch, or any other electronic device or computing system capable of storing, compiling, and organizing audio, visual, or textual data and receiving and sending that data to and from other computing devices, such as the computing device 104, the processing server 106, the payment network nodes 110, and/or the blockchain network nodes 114 via one or more communication methods, such as radio frequency, local area networks, wireless area networks, cellular communication networks, Bluetooth, the Internet, etc. It can be appreciated that any number of user computing devices 102A, 102B . . . 102N can be a part of the system 100 including a single user computing device 102 or more than one user computing device 102. The user computing devices 102A-N may be blockchain network nodes 114 in the blockchain network 112. In an exemplary embodiment, each user computing device 102 is associated with a cryptographic wallet, discussed in more detail below, associated with the blockchain network 112. For example, the user computing device 102A may be a smart phone of a user who has a cryptographic wallet to transact with other users, e.g., other user computing devices 102 and/or computing device 104, on the blockchain network 112. The user computing devices 102A-N may be implemented in the computer system 700 illustrated in FIG. 7 using hardware, software executed on hardware, firmware, non-transitory computer readable media having instructions stored thereon, or a combination thereof and may be implemented in one or more computer systems or other processing systems.

The computing device 104 may be a desktop computer, a notebook, a laptop computer, a tablet computer, a handheld device, a smart-phone, a thin client, a smartwatch, or any other electronic device or computing system capable of storing, compiling, and organizing audio, visual, or textual data and receiving and sending that data to and from other computing devices, such as the user computing devices 102A-N, the processing server 106, the payment network nodes 110, and/or the blockchain network nodes 114 via one or more communication methods, such as radio frequency, local area networks, wireless area networks, cellular communication networks, Bluetooth, the Internet, etc. It can be appreciated that any number of computing devices 104 can be a part of the system 100 including a single computing device 104 or more than one user computing device 104. In exemplary embodiments, the computing devices 104 is associated with a merchant. The computing device 104 may be, for example, a merchant point-of-sale device or a merchant server hosting a merchant website through which a user may purchase goods and/or services. Further, the computing device 104 may be a blockchain network node 114 in the blockchain network 112. The computing device 104 may be implemented in the computer system 700 illustrated in FIG. 7 using hardware, software executed on hardware, firmware, non-transitory computer readable media having instructions stored thereon, or a combination thereof and may be implemented in one or more computer systems or other processing systems.

The processing server 106 may be a desktop computer, a notebook, a laptop computer, a tablet computer, a handheld device, a smart-phone, a thin client, a smartwatch, or any other electronic device or computing system capable of storing, compiling, and organizing audio, visual, or textual data and receiving and sending that data to and from other computing devices, such as the user computing devices 102A-N, the computing devices 104A-N, the payment network nodes 110, and/or the blockchain network nodes 114 via one or more communication methods, such as radio frequency, local area networks, wireless area networks, cellular communication networks, Bluetooth, the Internet, etc. In some cases, the processing server 106 may be a payment network node in the payment network 110 and/or a blockchain network node 114 in the blockchain network 112. It can be appreciated that any number of processing servers 106 can be a part of the system 100 including a single processing server 106 or more than one processing server 106. The processing server 106 may be implemented in the computer system 700 illustrated in FIG. 7 using hardware, software executed on hardware, firmware, non-transitory computer readable media having instructions stored thereon, or a combination thereof and may be implemented in one or more computer systems or other processing systems.

The payment network 108 may be a system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via the payment network 108 may include product or service purchases, credit purchases, debit transactions, fund transfers, account withdrawals, etc. The payment network 108 may be configured to perform transactions via cash-substitutes, which may include payment cards, letters of credit, checks, transaction accounts, etc. Examples of networks or systems configured to perform as the payment network 108 include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network. For example, the payment network 108 may include payment rails which is the infrastructure associated with the payment network 108 used in the processing of payment transactions and the communication of transaction messages and other similar data between the payment network 108 and other entities interconnected with the payment network that handles thousands, millions, and even billions of transactions during a given period. The payment rails may be comprised of the hardware used to establish the payment network 108 and the interconnections between the payment network 108 and other associated entities, such as financial institutions, gateway processors, etc. In some instances, payment rails may also be affected by software, such as via special programming of the communication hardware and devices that comprise the payment rails. For example, the payment rails may include one or more payment network nodes, e.g., payment network nodes 110, specifically configured for the routing of transaction messages, which may be specially formatted data messages that are electronically transmitted via the payment rails, as discussed in more detail below.

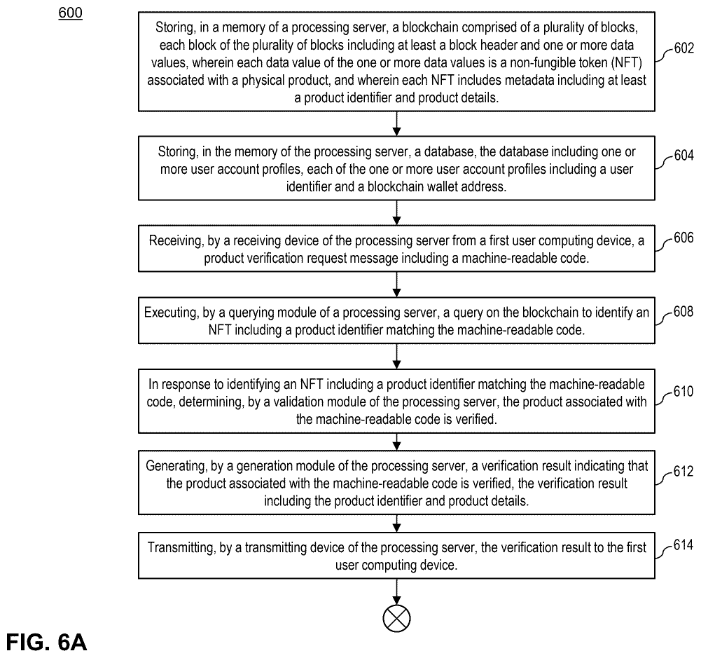

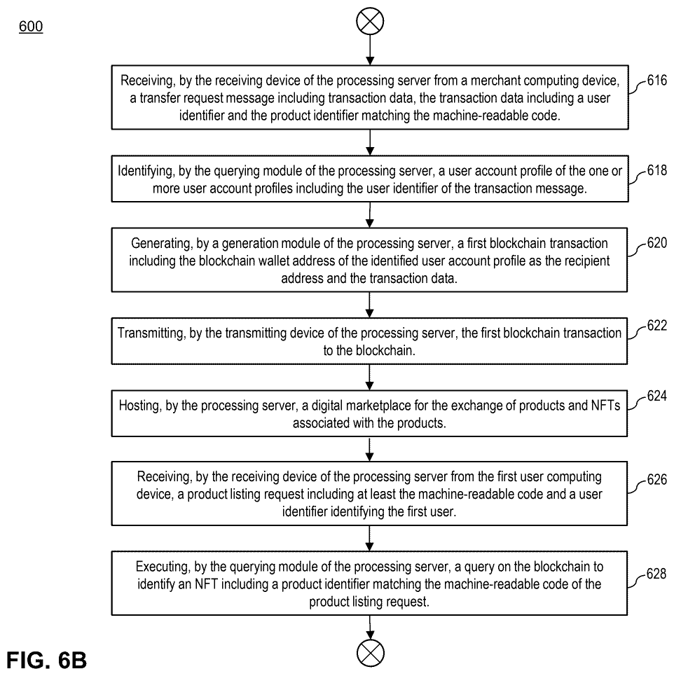

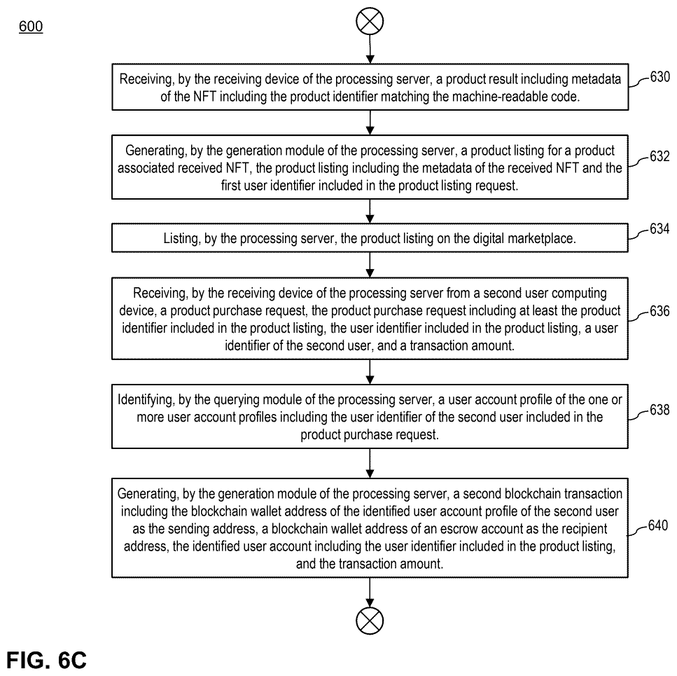

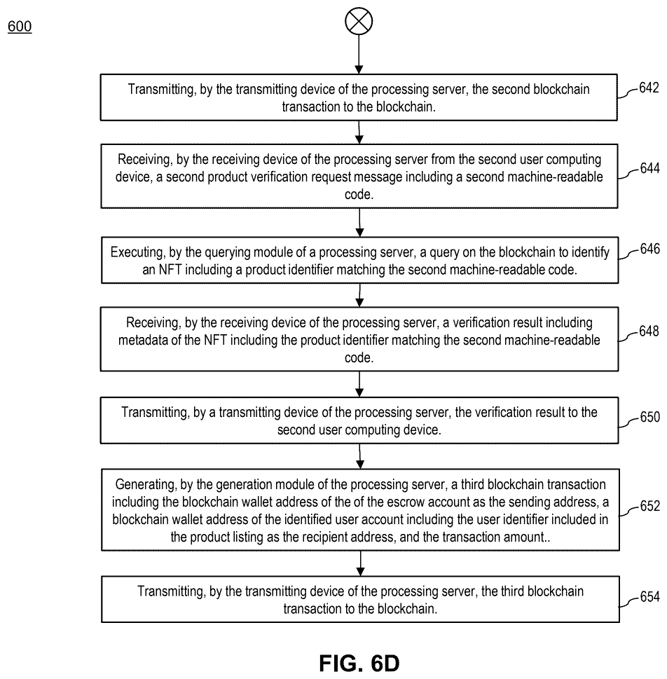

The blockchain network 112 is a network that enables users, e.g., the blockchain network nodes 114, to generate, list, and transact digital assets associated with physical assets transacted between parties and the blockchain network 112 enables the verification of physical assets based on the associated digital assets stored on the blockchain. The blockchain network 112 may be any suitable network configuration enabling communications between one or more users, e.g., the exchange network nodes 114. For example, the blockchain network 112 can be, but is not limited to, a peer-to-peer exchange and/or a decentralized exchange, etc. The blockchain network 112 may be comprised of a plurality of exchange network nodes 114. Each exchange network node 114 can be a computing system, such as illustrated in FIG. 6, discussed in more detail below, that is configured to perform functions related to the processing and management of the blockchain network 112, including the generation and storage of user profiles 208, generation and storage of digital tokens, user account profiles, generating and storing smart contracts, generation of digital token transactions, verification of proposed digital token transactions, verification of physical assets, verification of digital signatures, generation of new blocks, validation of new blocks, and maintenance of the blockchain. In exemplary embodiments, the user computing devices 102A-N, the computing device 104, and the processing server 106 can be blockchain network nodes 114.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node, e.g., blockchain network nodes 114, in the blockchain network, e.g., the blockchain network 112, prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions e.g., digital asset exchanges/purchases, conducted between two different blockchain wallets, e.g., wallets belonging to a user computing device 102 and a computing device 104. A blockchain wallet can include a private key of a cryptographic key pair that is used to generate digital signatures that serve as authorization by a payer for a blockchain transaction, where the digital signature can be verified by the blockchain network, e.g., the blockchain network 112, using the public key of the cryptographic key pair. In some cases, the term “blockchain wallet” can refer specifically to the private key. In other cases, the term “blockchain wallet” can refer to a computing device (e.g., user computing devices 102A-N, computing device 104, and/or blockchain network nodes 114, etc.) that stores the private key for use thereof in blockchain transactions. For instance, each computing device, e.g., each blockchain network node 114, can each have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable, such as a digital asset, e.g., a digital token. A blockchain transaction can consist of at least: a digital signature of the sender of data and/or currency (e.g., a user computing device 102) that is generated using the sender's private key, a blockchain address of the recipient of the data and/or currency (e.g., another user computing device 102) generated using the recipient's public key, and a digital asset that is transferred, or other data being stored. In some blockchain transactions, the transaction can also include one or more blockchain addresses of the sender where a digital asset is currently stored (e.g., where the digital signature proves their access to such digital asset such), as well as an address generated using the sender's public key for any change that is to be retained by the sender. Addresses to which currency and/or data have been sent that can be used in future transactions are referred to as “output” addresses, as each address was previously used to capture output of a prior blockchain transaction, also referred to as “unspent transactions,” due to there being currency and/or data sent to the address in a prior transaction where that currency and/or data is still unspent, e.g., not redeemed. In some cases, a blockchain transaction can also include the sender's public key, for use by an entity in validating the transaction. For the traditional processing of a blockchain transaction, such data can be provided to a blockchain node, e.g., a blockchain network node 114, in the blockchain network, e.g., the blockchain network 112, either by the sender or the recipient. The blockchain node can verify the digital signature using the public key in the cryptographic key pair of the sender's wallet and also verify the sender's access to the currency and/or data (e.g., that the unspent transactions have not yet been spent and were sent to address associated with the sender's wallet), a process known as “confirmation” of a transaction, and then include the blockchain transaction in a new block. The new block can be validated by other blockchain nodes, e.g., blockchain network nodes 114, in the blockchain network, e.g., the blockchain network 112, before being added to the blockchain and distributed to all of the blockchain nodes in the blockchain network, respectively, in traditional blockchain implementations. In cases where a blockchain data value cannot be related to a blockchain transaction, but instead the storage of other types of data, blockchain data values can still include or otherwise involve the validation of a digital signature.

In the system 100, the user computing devices 102A-N, the computing device 104, the processing server 106, and/or the blockchain network nodes 114 can create a new blockchain wallet for use with the blockchain. The blockchain wallet can be used by the user computing devices 102A-N, the computing device 104, the processing server 106, and/or the blockchain network nodes 114 to receive or transfer digital assets, cryptographic currency, and/or other value that is transferred or otherwise has ownership maintained via the blockchain network 112.

In embodiment, the blockchain network 112 stores digital twins of physical assets that are transacted between two parties, e.g., the blockchain nodes 114. The digital twin may be a digital token or any suitable digital asset representing the physical asset. For example, the digital twin may be a non-fungible token (NFT) that includes metadata related to the physical asset the NFT represents. The NFT metadata can include a physical asset identifier (e.g., a serial number, a stock keeping unit (SKU), a universal product code (UPC), a style code, an item number, an alphanumeric string, etc.), a product name, a photograph or image of the physical asset, a product manufacturer, a product distributor, past transactions involving the product, product origin, product description, product condition, product color, product size, current owner of the product (e.g., a user identifier), royalty rates to be charged for subsequent sales of the physical asset, or any other physical asset details, etc. In the system 100, a manufacturer or initial owner of a physical asset, e.g., the computing device 104, creates and registers the digital twin on the blockchain network 112 at the same time or shortly after the physical asset is manufactured. The physical asset can be any tangible good or product that can be transacted between two parties.

In the system 100, a physical asset that is to be transacted between two parties, e.g., the user computing devices 102A-N and the computing device 104, includes a machine-readable code that corresponds to a digital asset stored on the blockchain network 112. For example, a product manufacturer or original owner of the physical asset, e.g., the computing device 104, submits a registration request to a blockchain network node 114, e.g., the processing device 106, including physical asset information such as a product identifier (e.g., a serial number, a stock keeping unit (SKU), a universal product code (UPC), a style code, an item number, an alphanumeric string, etc.), a product name, a photograph or image of the physical asset, a product manufacturer, a product distributor, past transactions involving the product, product origin, product description, product condition, product color, product size, current owner of the product (e.g., a user identifier), product sale price, royalty rates to be charged for subsequent sales of the physical asset, and/or any other physical asset details, etc. The blockchain network node 114, e.g., the processing server 106, generates a digital twin corresponding to the physical asset. For example, blockchain network node 114, e.g., the processing server 106, generates an NFT of the physical asset based on the product information in the registration request. The blockchain network node 114, e.g., the processing server 106, then generates a blockchain transaction including the NFT and submits the blockchain transaction to the blockchain network 114 for confirmation. Once the blockchain network 112 confirms the blockchain transaction including the NFT and adds the blockchain transaction to the blockchain, the NFT is minted. The minting of the NFT also causes the NFT to be added to the product manufacturer's or original owner's, e.g., the computing device 104, blockchain wallet. Prior to registering the physical asset, the product manufacturer or original owner of the physical asset, e.g., the computing device 104, registers with the system 100 as discussed in more detail below. Once the digital asset associated with the physical asset has been created and registered, the product manufacturer or original owner of the physical asset, e.g., the computing device 104, can then proceed to sell the physical asset, e.g., online or at a brick-and-mortar store.

As discussed above, a physical asset having a digital twin stored on the blockchain network 112 includes a machine-readable code physically located on or otherwise suitably attached to the physical asset that corresponds to the product identifier included in the corresponding digital twin. For example, the machine-readable code may be any suitable representation of the product identifier including a the product identifier, a hash of the product identifier, or any suitable representation of the product identifier capable of being read by a computing device, e.g., the user computing devices 102A-N, the computing device 104, the processing server 106, and/or the blockchain nodes 114. While the machine-readable code is described herein as corresponding to the product identifier, it can be appreciated that the machine-readable code can be a representation of any suitable product identifying information, e.g., any information included in the NFT metadata. The machine-readable code can be attached to the physical asset in any suitable manner such as embedded in a near field communication (NFC) chip attached to or embedded in the physical asset, encoded in a quick response (QR) code, printed on the physical asset, etched on the physical asset, or any other suitable attachment method, etc. In embodiments, the machine-readable code is physically associated with the physical asset in a secure way to prevent alteration of the machine-readable code and/or removal of the machine-readable code. As an example, the machine-readable code can be an NFC chip that is incorporated, e.g., embedded, into the physical asset, such as in the tongue or sole of a shoe. The blockchain network 112 enables the verification of the authenticity of physical assets based on the stored digital assets and the machine-readable code. For example, a user, e.g., the user computing device 102A may start a purchase of a physical asset including a machine-readable code. Prior to executing the purchase of the physical asset, the user, e.g., the user computing device 102 A can verify that the physical asset to be purchased is authentic. The user scans, or otherwise reads, the machine-readable code via the user computing device 102A. The user computing device 102A may scan or read the machine-readable code using a camera, a near-field communication (NFC) interface, radio frequency (RF), Bluetooth, or any other suitable input device or protocol, etc. Alternatively, a user may manually enter the machine-readable code when possible, using the user computing device 102A, e.g., via keyboard. In embodiments, the user, e.g., the user computing device 102A, is registered with the system 100, as discussed in more detail below. The user computing devices 102A-N can communicate with the blockchain network nodes 114 by accessing an interface of the blockchain network 112, e.g., a website, an application, a server, or any other suitable portal for accessing a network platform. The user, e.g., the user computing device 102A, generates a verification request including the machine-readable code and transmits the verification request to a blockchain network node 114, e.g., the processing server 106. In embodiments, the user computing devices 102A-N can communicate with the blockchain network nodes 114, e.g., the processing server 106, via the computing device 104. In such embodiments, upon scanning the machine-ridable code on the physical asset, an interface, e.g., a mobile application, of the computing device 104 may launch on the user computing device 102A. For Example, the computing device 104 can be a merchant server hosting a platform, e.g., an application, a web portal, etc., and the user computing device 102A can access an interface of the computing device 104, e.g., a website, an application, or any other suitable portal for accessing a network platform. The user computing device 102A can transmit the verification request to the computing device 104, e.g., by entering the request into a merchant mobile application of the computing device 104, which then transmits the verification request to the blockchain network nodes 114, e.g., the processing server 106.The blockchain network node 114, e.g., the processing server 106, may execute a query on the blockchain to identify a product identifier, e.g., included in an NFT, that matches or corresponds to the machine-readable code of the verification request. If the blockchain network node 114, e.g., the processing server 106, identifies a matching product identifier on the blockchain, the blockchain network node 114, e.g., the processing server 106, determines that the machine-readable code is verified, e.g., authentic. The blockchain network node 114, e.g., the processing server 106, generates a verification result indicating that the product associated with the machine-readable code is verified. The verification result includes at least the product identifier and the product details, e.g., the product details included in the identified NFT's metadata. The blockchain network node 114, e.g., the processing server 106, transmits the verification result to the user computing device 102A. The blockchain network node 114, e.g., the processing server 106, can transmit the verification result to the user computing device 102A directly or via the computing device 104, e.g., via a mobile application of the computing device 104. Upon receipt of the verification result, the user, e.g., the user computing device 102A, can confirm that the product details included in the verification result match the physical asset to be purchased. The user computing device 102A receives the verification result via the interface of the blockchain network 112, e.g., a website, an application, a server, or any other suitable portal for accessing a network platform. If the product details included in the verification result match the physical asset to be purchased, the user, e.g., the user computing device 102A, can proceed with executing the purchase of the physical asset.

In embodiments, users of the system 100, e.g., the user computing devices 102A-N and computing device 104, register with the system. Continuing with the example above, if the user, e.g., the user computing device 102A, is not registered with the system 100 at the time of purchase of the physical asset, the interface of the blockchain network 112, e.g., a website, an application, a server, or any other suitable portal for accessing a network platform, will prompt the user computing device 102A to create a user profile. In embodiments, the user enters a user contact address, e.g., an e-mail address, or mobile phone number, via the interface of the blockchain network 112 on the user computing device 102A to begin creation of a user account profile. In response to the user entering the user contact address or mobile phone number, the system 100, e.g., via the processing server 106, generates and transmits a one-time password to the entered user contact address or mobile phone number, e.g., via e-mail, SMS, or any other suitable communication method. The processing server 106 prompts the user, via the interface of the blockchain network 112 on the user computing device 102A, to enter the transmitted one-time password to continue with the creation of the user account profile. The processing server 106 verifies that the one-time password entered by the user, via the user computing device 102A, matches the one-time password sent by the processing server 106. If the one-time password entered by the user, via the user computing device 102A, matches the one-time password sent by the processing server 106, the processing server 106 prompts, e.g., via the interface of the blockchain network 112 on the user computing device 102A, to enter user account profile information including, a username, a user device identifier, e.g., a serial number of user computing device 102A, etc., a user's first and/or last name, user location data, payment account details, e.g., a blockchain wallet, a preferred blockchain network, e.g., a network where the user would like to receive any digital assets, a preferred transaction currency, e.g., a preferred cryptocurrency or preferred fiat currency, and/or any other suitable user information, etc. Once the user has created a user account profile, the processing server 106 generates a custodial wallet for the user on the blockchain network 112 for receiving any digital assets via the blockchain network 112. Similar to the process described above for the user, e.g., the user computing device 102A, the product manufacturer or original owner of the physical asset, e.g., the computing device 104, or any other user of the system 100 follows the same process to create a user account profile.

Returning to the purchase of a physical asset, once a user has created a user account profile, the processing server 106 determines the preferred blockchain network and/or the preferred transaction currency included in the user's user account profile and the preferred blockchain network and/or the preferred transaction currency included in the seller's user account profile and/or included in the NFT metadata associate with the physical asset being purchased. If the processing server 106 determines that that the preferred blockchain network and and/or the preferred transaction currency included in the user's user account profile matches the preferred blockchain network and/or the preferred transaction currency included in the seller's user account profile and/or included in the NFT metadata associate with the physical asset being purchased, the processing server can prompt the user, e.g., via the interface of the blockchain network 112 on the user computing device 102A, to select a payment method. If the processing server 106 determines that that the preferred blockchain network and and/or the preferred transaction currency included in the user's user account profile does not match the preferred blockchain network and/or the preferred transaction currency included in the seller's user account profile and/or included in the NFT metadata associate with the physical asset being purchased, the processing server can display an exchange rate to the user, e.g., via the interface of the blockchain network 112 on the user computing device 102A. The user can then select a payment method. The payment method may be any suitable payment instrument for conducting an electronic payment transaction such as a payment (e.g., ApplePay®, Zelle®, PayPal®, Venmo®, etc.), a cryptocurrency, a credit card, a debit card, etc. Once the user has selected an electronic payment method, the processing server 106 tokenizes the selected payment method, e.g., the payment account number associated with the payment instrument, generating a tokenized card NFT, which is then stored in the user's blockchain wallet on the blockchain network 112. The tokenization of payment instruments enables payments between parties, e.g., the user computing device 102A and the computing device 104, with different preferred currencies. For example, the user computing device 102A may prefer to pay for a physical asset in Token A, e.g., Bitcoin, and the seller, e.g., the computing device 104, may prefer to be paid in a fiat currency, e.g., the U.S. dollar. Tokenized payment instrument NFTs are disclosed in more detail in U.S. patent application No. Ser. No. 18/368,749 filed on Sep. 15, 2023, entitled “DIGITIZATION OF PAYMENT CARDS FOR WEB 3.0 AND METAVERSE TRANSACTIONS”, the contents of which are hereby incorporated by reference in their entirety. In this way, the blockchain network 112 functions as a cross-chain network, e.g., the blockchain network can communicate with various other blockchain networks. Cross-chain networks are described more fully in U.S. Pat. No. 11,689,355 issued on Jun. 27, 2023, entitled “METHOD AND SYSTEM FOR THE ATOMIC EXCHANGE OF BLOCKCHAIN ASSETS USING TRANSIENT KEY PAIRS,” the contents of which are incorporated herein by reference in their entirety. Alternatively, the user, e.g., the user computing device 102A, and the seller, e.g., the computing device 104, can execute payment for the physical asset via traditional payment methos, e.g., via the payment network 108. If traditional payment methods are used, the user, e.g., the user computing device 102A, and/or the seller, e.g., the computing device 104, can transmit a confirmation message to the processing server 106. Once the payment for the physical asset is confirmed, the processing server 106 generates a blockchain transaction transferring the digital asset, e.g., an NFT, associated with the physical asset that was purchased from the seller, e.g., the computing device 104, to the user, e.g. the user computing device 102A. For example, the processing server 106 generates a blockchain transaction including the user's blockchain wallet as the recipient address, the seller's wallet as the sending address, and the NFT associated with the physical asset that was purchased. The processing server transmits the blockchain transaction to the blockchain network 112 for confirmation and addition to the blockchain. Once the blockchain transaction is confirmed and added to the blockchain the digital asset, e.g., the NFT, associated with the physical asset that was purchased is deposited in the user's custodial wallet on the blockchain network 112. Furthermore, as part of the confirmation process, the NFT metadata is updated to reflect the transaction from the seller, e.g., the computing device 104, to the user, e.g., the user computing device 102A.

In embodiments, the computing device 104 and/or the processing server 106 can host a digital marketplace for the exchange of physical assets. For example, the computing device 104 can be a merchant that hosts an online marketplace, e.g., a website, web portal, mobile application, or any other suitable platform, etc. that enables user, e.g., the user computing device 120A-N, to sell physical assets purchased from the merchant. In another example, the computing device 104 and/or the processing server 106 can host a third-party marketplace, e.g., a good/brand agnostic marketplace, which enables users, e.g., the user computing device 120A-N, to sell any physical assets that have an associated digital asset stored on the blockchain network 112. A user, e.g., the user computing device 102A, can list a physical asset on the marketplace following a similar procedure as described above for registering a physical asset with the blockchain network 112 and purchasing a physical asset from a merchant, e.g., the computing device 104. A user wanting to list a physical asset for sale on a marketplace, scans or otherwise reads a machine-readable code attached to the physical asset they want to sell. The user computing device 102A then generates and transmits a product listing request to the processing server 106, e.g., directly or via the computing device 104 as discussed above. The physical asset is then verified following the same procedure as discussed above. Once the product has been verified, e.g., the processing server 106 returns a verification result, the user will be prompted to create a listing for the physical asset. For example, the processing server 106 and/or the computing device 104 presents the user with a product listing page via an interface of the processing server 106 and/or the computing device 104. The user, via the user computing device 102A, enters physical asset information such as a product identifier (e.g., a serial number, a stock keeping unit (SKU), a universal product code (UPC), a style code, an item number, an alphanumeric string, etc.), a product name, a photograph or image of the physical asset, a product manufacturer, a product distributor, past transactions involving the product, product origin, product description, product condition, product color, product size, current owner of the product (e.g., a user identifier), product sale price, royalty rates to be charged for subsequent sales of the physical asset, and/or any other physical asset details, etc. The user, via the user computing device 102A, can enter sales information such as the currency in which they want to receive any sales proceeds of the physical product and the sale amount for the physical asset. The user, via the user computing device 102A, can enter seller information such as a suer identifier of the user of the user computing device 102A, e.g., the user information included in the user account profile of the user computing device 102A. Once the user has selected a preferred currency and set the sales amount, the computing device 104 and/or the processing server 106 may display a final sales amount the user will receive. For example, the final sales amount may be the set sales amount minus any fees required by the marketplace, e.g., royalties required by the manufacturer/original owner as defined in the digital asset associated with the physical asset, fees required by the marketplace for hosting the listing, estimated sales taxes, estimated shipping costs, etc. Once the user has entered all the physical asset information and sales information, the computing device 104 and/or the processing server 106, generates a physical asset listing for the physical asset on the marketplace and lists the physical asset listing on the marketplace enabling other users, e.g., user computing devices 102B-N, to view the physical asset listing. The computing device 104 and/or the processing server 106 may generate and transmit a confirmation message to the user, e.g., the user computing device 102A, via the marketplace interface.

Once a physical asset listing has been created on the marketplace, another user, e.g., user computing device 102B, may view the physical asset listing via the marketplace interface, e.g., mobile application, web portal, website hosted by the computing 104 and/or the processing server 106. The user computing device 102B can proceed to purchase the physical asset on the marketplace using any known payment method, e.g., via the payment network 110, a cryptocurrency network, etc. In embodiments, the user computing device 102B proceeds to purchase the physical asset using the payment method set, e.g., by the user computing device 102A, in the physical product listing on the marketplace. As part of the purchase process, the buyer, e.g., the user computing device 102B, enters personal information, e.g., all or some of the user information included in the user account profile associated with the user computing device 102B. Further, the transaction amount, e.g., the sales amount, may be deposited into an escrow account until the buyer, e.g., the user computing device 102B receives and verifies the physical asset as discussed in more detail below.

In embodiments, the payment may be a cryptocurrency payment processed by the blockchain network 112. In such embodiments, the computing device 104 and/or the processing server 106 may generate a blockchain transaction including the blockchain wallet of the user computing device 102A as the recipient address, the blockchain wallet of the user computing device 102B as the sending address, and transaction data including at least the transaction amount, e.g., the sales amount of the physical product listing. Once the payment has been processed, the computing device 104 and/or the processing server 106, generates and transmits a product purchase request to the blockchain network 112. The product purchase request includes at least the product identifier included in the physical asset listing, the user identifier included in the physical asset listing, a user identifier of the second user, e.g., the user computing device 102B, and a transaction amount. The blockchain node 114, e.g., the processing server 106, identifies a user account profile associated with the user computing device 102B including the user identifier of the second user included in the product purchase request. The blockchain node 114, e.g., the processing server 106, generates a blockchain transaction including the blockchain wallet address of the identified second user account profile, e.g., the user computing device 102B, as the sending address, a blockchain wallet address of an escrow account as the recipient address, the identified user account including the user identifier included in the physical product listing, e.g., of the user computing device 102A, and the transaction amount. The blockchain node 114, e.g., the processing server 106, transmits the blockchain transaction to the blockchain network 112 for confirmation and addition to the blockchain causing the transaction amount to be deposited in the escrow account. The escrow account is used to hold the transaction amount until the seller ships the physical asset and the buyer receives and verifies the physical asset. Further, after the payment has been processed, the seller, e.g., the user computing device 102A, sends the physical asset to the buyer, e.g., the user computing device 102B. For example, the seller, e.g., the user computing device 102A, ships the physical asset to the physical address of the buyer, e.g., the user computing device 102B.

Once the buyer, e.g., the user computing device 102B, receives the physical asset, the user computing device then verifies the physical asset in the same way as discussed above, e.g., scanning/reading the machine-readable code and submitting a verification request to the blockchain network 112. If the physical asset is verified, e.g., the blockchain node 114 transmits a positive verification result to the buyer, e.g., the user computing device 102B, the seller, e.g., the user computing device 102A, and/or the marketplace, e.g., the computing device 104 and/or the processing server 106, generates and transmits a transfer request message to the blockchain network 112. The transfer request includes at least transaction data including a user identifier of the user computing device 102B, and the product identifier matching the machine-readable code. The blockchain network node 114, e.g., the processing server 106, receives the transfer request and generates a blockchain transaction including at least the blockchain wallet address of the user account including the user identifier included in the product listing, e.g., the user computing device 102A, as the sending address, the blockchain wallet address of the identified second user account profile, e.g., the user computing device 102B, as the recipient address, and the transaction data. The blockchain network 112, e.g., a blockchain network node 114, transmits the blockchain transaction to the blockchain network 112 for confirmation and addition to the blockchain causing the digital asset associated with the purchased physical product to be transferred from the blockchain wallet of the seller, e.g., the user computing device 102A, to the blockchain wallet of the buyer, e.g., the user computing device 102B. Further, the marketplace, e.g., the computing device 104 and/or the processing server 106, processes payment of the escrow amount from the escrow account to the seller, e.g., the user computing device 102A. In embodiments where the escrow payment was processed by the blockchain network 112, the blockchain node 114, e.g., the processing server 106, generates a blockchain transaction including the identified user account including the user identifier included in the physical product listing, e.g., of the user computing device 102A, as the recipient address, the blockchain wallet address of an escrow account as the sending address, and the transaction amount. The blockchain node 114, e.g., the processing server 106, transmits the blockchain transaction to the blockchain network 112 for confirmation and addition to the blockchain causing the transaction amount to be deposited in the blockchain wallet of the seller, e.g., the user computing device 102A.

The methods and systems discussed herein provide for the registration, listing, sale, and exchange of digital assets, e.g., an NFT, associated with a physical asset via a blockchain network, e.g., the blockchain network 112. Further, the methods and systems discussed herein provide for the verification of authenticity of physical assets being transacted via use of a machine-readable code attached to the physical asset and corresponding to a digital asset stored on a blockchain, e.g., the blockchain network 112.

### Processing Server

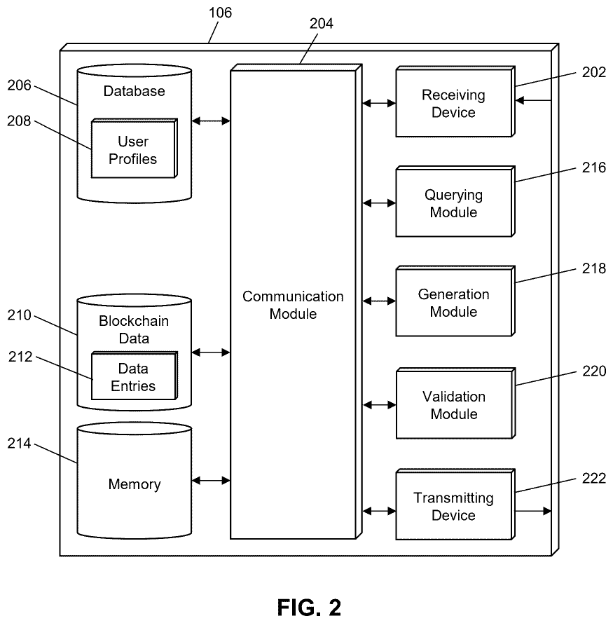

FIG. 2 illustrates an embodiment of the processing server 106 in the system 100 of FIG. 1. It will be apparent to persons having skill in the relevant art that the embodiment of the processing server 106 illustrated in FIG. 2 is provided as illustration only and is not exhaustive of all possible configurations of the processing server 106 suitable for performing the functions as discussed herein. For example, the computer system 700 illustrated in FIG. 7 and discussed in more detail below can be a suitable configuration of the processing server 106. In some cases, other components of the system 100, such as the user computing devices 102A-N, the computing device 104, the payment network nodes 110, and the blockchain network nodes 114 can include the components illustrated in FIG. 2 and discussed below.

The processing server 106 can include a receiving device 202. The receiving device 202 can be configured to receive data over one or more networks via one or more network protocols. In some instances, the receiving device 202 can be configured to receive data from the user computing devices 102A-N, the computing devices 104A-N, the payment network nodes 110, the blockchain network nodes 114, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by user computing devices 102A-N, the computing devices 104A-N, the payment network nodes 110, and the blockchain network nodes 114 that are superimposed or otherwise encoded with blockchain data entries, blockchain transactions, public keys, transaction requests, physical asset verification requests, transfer requests, physical asset listing requests, physical asset purchase requests, verification messages, registration requests, etc. The receiving device 202 can also be configured to receive data signals electronically transmitted by user computing devices 102A-N, the computing devices 104A-N, the payment network nodes 110, the blockchain network nodes 114, which can be superimposed or otherwise encoded with registration data for new blockchain wallets, public keys, portions of transaction account numbers, hashed transaction account numbers, new blockchain transactions, etc. The receiving device 202 can also be configured to receive data signals electronically transmitted by payment network nodes 110 that can be superimposed or otherwise encoded with transaction data, etc.

The processing server 106 can also include a communication module 204. The communication module 204 can be configured to transmit data between modules, engines, databases, memories, and other components of the processing server 106 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 106 and external components of the processing server 106, such as externally connected databases, display devices, input devices, etc. The processing server 106 can also include a processing device. The processing device can be configured to perform the functions of the processing server 106 discussed herein as will be apparent to persons having skill in the relevant art. In some embodiments, the processing device can include and/or be comprised of a plurality of engines and/or modules specially configured to perform one or more functions of the processing device, such as the querying module 216, generation module 218, validation module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 106 can also include the database 206. The database 206 can be configured to store one or more user profiles 208 using a suitable data storage format and schema. The database 206 can be a relational database that utilizes structured query language for the storage, identification, modifying, updating, accessing, etc. of structured data sets stored therein. The profile database may include one or more user profiles 208. Each user profile 208 can be a structured data set configured to store data related to a user, e.g., the user computing devices 102A-N. A user profile 208 can include, for example, a username, a user device identifier, e.g., a serial number of user computing device 102A, etc., a user's first and/or last name, user location data, payment account details, e.g., a blockchain wallet, a preferred blockchain network, e.g., a network where the user would like to receive any digital assets, a preferred transaction currency, e.g., a preferred cryptocurrency or preferred fiat currency, and/or any other suitable user information, etc. In some embodiments, the database 206 can be a lookup table that can be accessed by the processing server 106 and one or more systems external to the processing server 106, such as user computing devices 102, the computing device 104, the payment network nodes 110, and the blockchain network nodes 114, etc. In some embodiments, the database 206 can be a sidechain, which can be accessed by the processing server 106 and one or more systems external to the processing server 106, such as user computing devices 102, the computing device 104, the payment network nodes 110, and the blockchain network nodes 114, etc.

The processing server 106 can also include blockchain data 210. The blockchain data 210 an include any data entries 212 associated with the blockchain network 112, e.g., a copy of the blockchain associated with the blockchain network 112, and/or data associated with the sidechain, e.g., the database 206 as described above.

The processing server 106 can also include a memory 214. The memory 214 can be configured to store data for use by the processing server 106 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 106 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys, cryptographic key pairs, cryptographic algorithms, encryption algorithms, communication information, data formatting rules, network identifiers, transaction histories, blockchain wallet data, user profile data, or any data stored in the database 206, blockchain data 210, etc.

The processing server 106 can include a querying module 216. The querying module 216 can be configured to execute queries on databases to identify information. The querying module 216 can receive one or more data values or query strings and can execute a query string based thereon on an indicated database, such as the database 206 of the processing server 106 to identify information stored therein. The querying module 216 can then output the identified information to an appropriate engine or module of the processing server 106 as necessary. The querying module 216 can, for example, execute a query on the database 206 to identify a user profile 208 associated with a user computing device 102A-N and/or computing device 104.

The processing server 106 can also include a generation module 218. The generation module 218 can be configured to generate data for use by the processing server 106 in performing the functions discussed herein. The generation module 218 can receive instructions as input, can generate data based on the instructions, and can output the generated data to one or more modules of the processing server 106. For example, the generation module 218 can be configured to generate blockchain data entries, blockchain transactions, public keys, transaction requests, physical asset verification requests, transfer requests, physical asset listing requests, physical asset purchase requests, verification messages, registration requests, etc.

The processing server 106 can also include a validation module 220. The validation module 220 can be configured to perform validations for the processing server 106 as part of the functions discussed herein. The validation module 220 can receive instructions as input, which can also include data to be used in performing a validation, can perform a validation as requested, and can output a result of the validation to another module or engine of the processing server 106. The processing server 106 may approve or deny a loyalty point transaction request based on the result of a validation.

The processing server 106 can also include a validation module 220. The validation module 220 can be configured to perform validations for the processing server 106 as part of the functions discussed herein. The validation module 220 can receive instructions as input, which can also include data to be used in performing a validation, can perform a validation as requested, and can output a result of the validation to another module or engine of the processing server 106. The processing server 106 may approve or deny a loyalty point transaction request based on the result of a validation.

The processing server 106 can also include a transmitting device 222. The transmitting device 222 can be configured to transmit data over one or more networks via one or more network protocols. In some instances, the transmitting device 222 can be configured to transmit data to the user computing devices 102, the computing device 104, the payment network nodes 110, the blockchain network nodes 114, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to user computing devices 102, the computing device 104, the payment network nodes 110, the blockchain network nodes 114 that are superimposed or otherwise encoded with blockchain data entries, blockchain transactions, public keys, transaction requests, physical asset verification requests, transfer requests, physical asset listing requests, physical asset purchase requests, verification messages, registration requests, etc.

### Process for Cross-Network Transactions

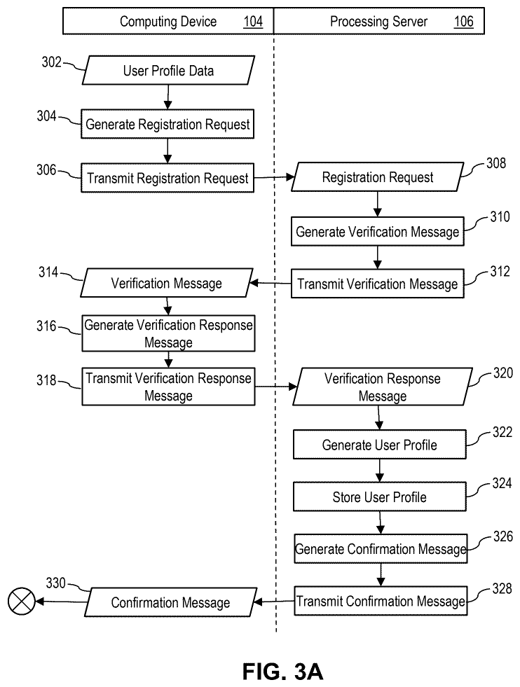

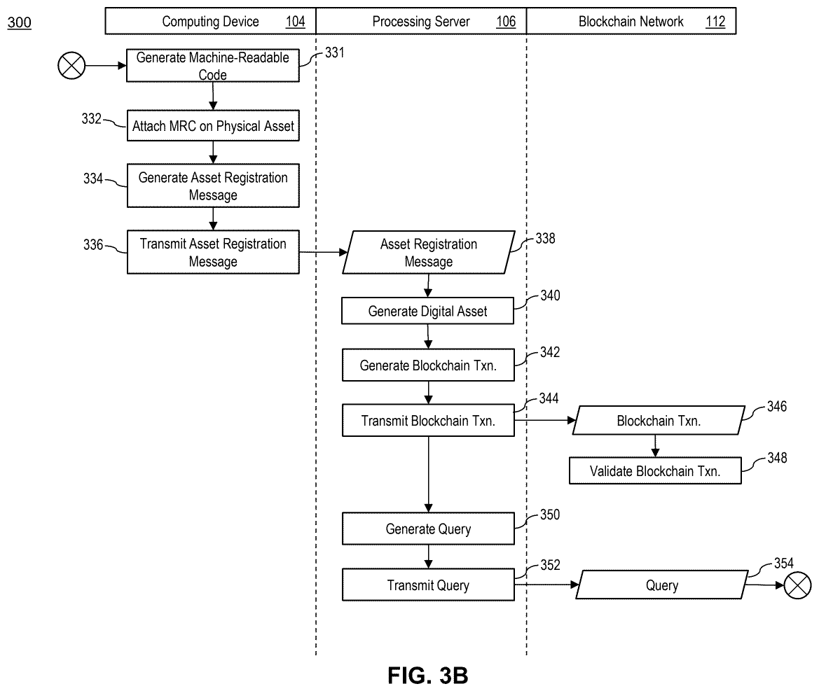

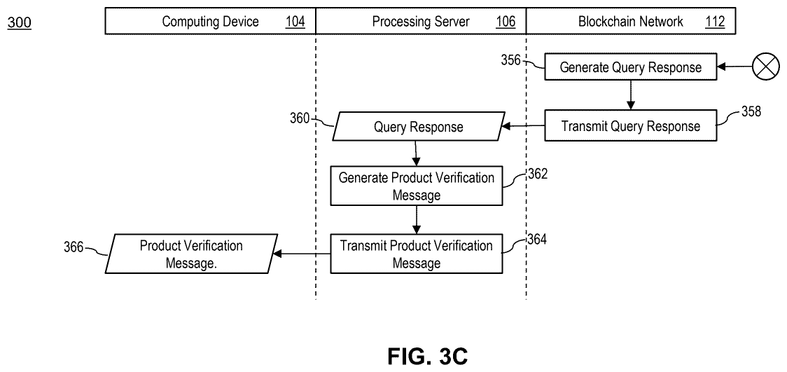

FIGS. 3A-3C illustrate process 300 for cross-network transactions via the system 100 of FIG. 1. More particularly, FIGS. 3A-3C illustrate a process for registering a user, registering a physical asset, generating a digital asset associated with the physical asset, and verifying a physical asset in the system 100.

In step 302, a user (e.g., the user computing devices 102A-N and/or the computing device 104) generates user contact data such as a user contact address, e.g., an e-mail address, or mobile phone number, via an interface of the blockchain network 112 and/or other network hosted by the processing server 106 on the user computing device (e.g., the user computing device 102A-N and/or computing device 104) to begin creation of a user profile (e.g., a user profile 208).

In step 304, the user (e.g., the user computing devices 102A-N and/or the computing device 104) generates a registration request including the user contact data and/or the user data and transmits the registration request to the processing server 106 in step 306.

In step 308, the processing server 106 receives the registration request from the user (e.g., the user computing devices 102A-N and/or the computing device 104) and generates a verification message in step 310. The verification message includes at least a one-time password to verify the identity of the user. In step 312, the processing server 106 transmits the verification message to the user contact address, e.g., email address and/or mobile phone number, of the user (e.g., the user computing device 102A-N and/or the computing device 104).

In step 314, the user (e.g., the user computing device 102A-N and/or the computing device 104) receives the verification message and generates a verification response message including at least the one-time password. In step 318, the user (e.g., the user computing device 102A-N and/or the computing device 104) transmits the verification response message to the processing server 106. For example, the user may enter the one-time password into the interface of the blockchain network 112 and/or other network hosted by the processing server 106 on the user computing device (e.g., the user computing device 102A-N and/or computing device 104).

In step 320, the processing server 106 receives the verification response message from the user (e.g., the user computing device 102A-N and/or the computing device 104). In response to verifying the user (e.g., the user computing devices 102A-N and/or the computing device 104), the processing server can prompt, e.g., via the interface of the blockchain network 112 on the user computing device 102A-N and/or the computing device 104, to enter user profile information including, a username, a user device identifier, e.g., a serial number of user computing device 102A, etc., a user's first and/or last name, user location data, payment account details, e.g., a blockchain wallet, a preferred blockchain network, e.g., a network where the user would like to receive any digital assets, a preferred transaction currency, e.g., a preferred cryptocurrency or preferred fiat currency, and/or any other suitable user information, etc. The processing server 106 generates a user profile for the user (e.g., the user computing device 102A-N and/or the computing device 104) using the user profile data in step 322 and stores the user profile in a database, e.g., the database 206, in step 324. Further, once the user profile has been generated, the processing server 106 generates a custodial wallet for the user e.g., the user computing devices 102A-N and/or the computing device 104) on the blockchain network 112 for receiving any digital assets via the blockchain network 112.

In step 326, the processing server 106 generates a confirmation message confirming the creation of the user profile (e.g., the user profile 208) and transmits the confirmation message to the user (e.g., the user computing device 102A-N and/or the computing device 104) in step 328.

In step 330, the user (e.g., the user computing device 102A-N and/or the computing device 104) receives the confirmation message.

In step 331, the user (e.g., the user computing device 102A-N and/or the computing device 104) generates a machine-readable code for a physical asset and attaches the machine-readable code to the physical asset in step 332. Generation and attachment of the machine-readable code to a physical asset is discussed in more detail above.

In step 334, the user (e.g., the user computing device 102A-N and/or the computing device 104) generates an asset registration message. The asset registration message including physical asset information such as a product identifier (e.g., a serial number, a stock keeping unit (SKU), a universal product code (UPC), a style code, an item number, an alphanumeric string, etc.), a product name, a photograph or image of the physical asset, a product manufacturer, a product distributor, past transactions involving the product, product origin, product description, product condition, product color, product size, current owner of the product (e.g., a user identifier), product sale price, royalty rates to be charged for subsequent sales of the physical asset, and/or any other physical asset details, etc. The user (e.g., the user computing device 102A-N and/or the computing device 104) transmits the asset registration message to the processing server 106 in step 336.

In step 338, the processing server 106 receives the asset registration message and generates a digital asset based on the physical asset information included in the asset registration message in step 340. For example, the processing server 106 generates an NFT based on the physical asset information. In steps 342-348, the processing server 106 stores and/or mints the digital asset on a blockchain, e.g., the blockchain of the blockchain network 112. In step 342, the processing server 106 generates a blockchain transaction including the digital asset and submits the blockchain transaction to the blockchain network 112 at step 344. The blockchain network 112 receives the blockchain transaction at step 346 and validates, e.g., via a blockchain network node 114, the blockchain transaction and adds the blockchain transaction to the blockchain in step 348.

In step 350, the processing server 106 generates a query to confirm the digital asset has been added to the blockchain (e.g., the blockchain of the blockchain network 112) and transmits the query to the blockchain network 112 in step 352.

In step 354, the blockchain network 112 receives the query from the processing server 106. In step 356, the blockchain network 112 (e.g., via a blockchain network node 114) generates a query response indicating the blockchain transaction including digital asset has been added and stored on the blockchain and transmits the query response to the processing server 106 in step 358.

In step 360, the processing server 106 receives the query response from the blockchain network 112. In step 362, the processing server 106 generates a product verification message indicating the digital asset was successfully added to the blockchain network 112. In step 364, the processing server transmits the product verification message to the user (e.g., the user computing device 102A-N and/or the computing device 104) and the user (e.g., the user computing device 102A-N and/or the computing device 104) receives the product verification message in step 366.

In exemplary embodiments, steps 302-330 illustrate the process for any user to create a profile and register with the system 100. In exemplary embodiments, steps 331-366 illustrate the process for a manufacturer and/or original owner of a physical asset to initially register and create a digital twin for the physical asset in the system 100.

### Process for Cross-Network Transactions

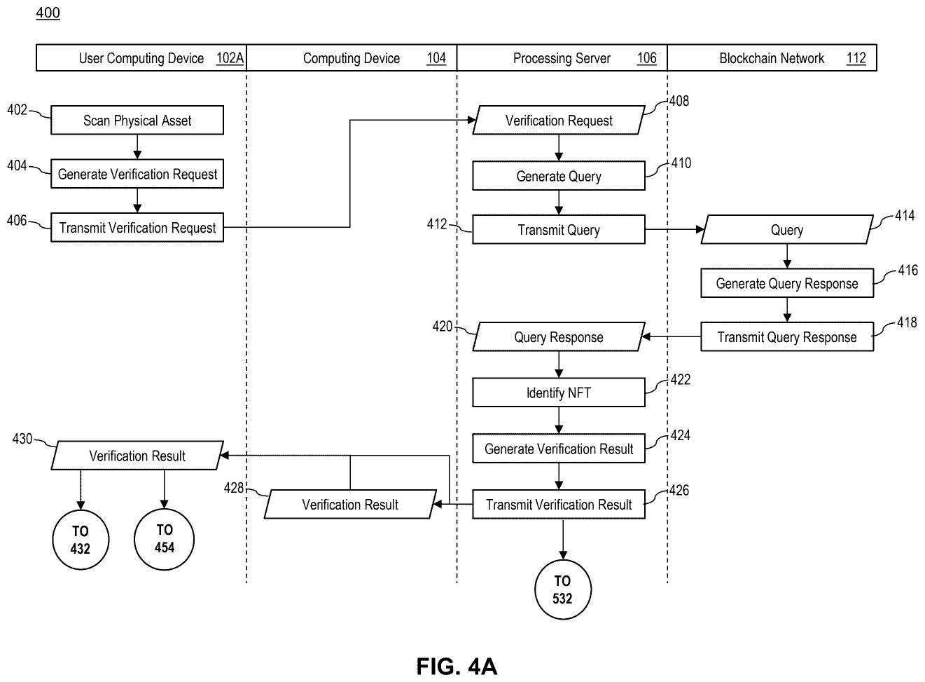

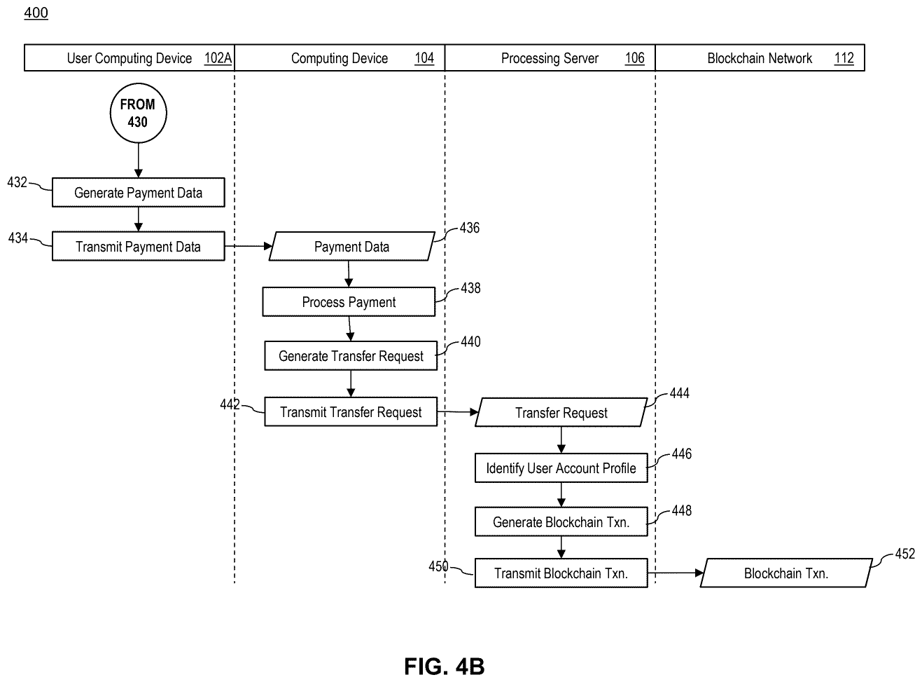

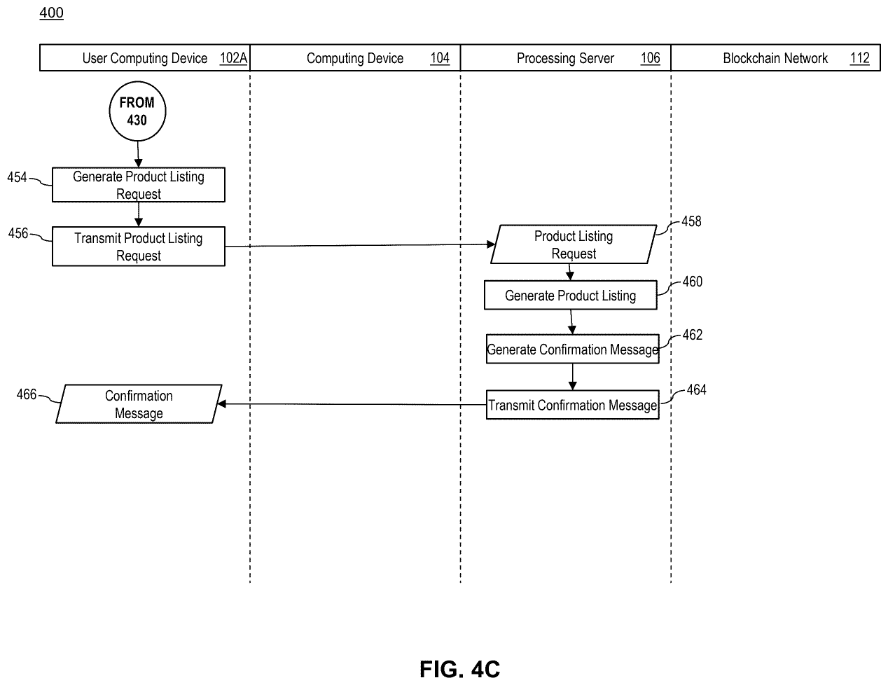

FIGS. 4A-4C illustrate process 400 for cross-network transactions via the system 100 of FIG. 1. More particularly, FIGS. 4A-4C illustrate a process for verifying and purchasing a physical asset in the system 100.

In step 402, a user (e.g., the user computing device 102A) who wants to purchase a physical asset having an attached machine-readable code, scans or otherwise reads the machine-readable code, e.g., using the user computing device 102A as discussed in more detail above. In response to scanning the machine-readable code, the user will be prompted, e.g., via the user computing device 101A, to launch a marketplace interface, e.g., a marketplace hosted by the computing device 104 and/or the processing server 106, such as a mobile application, web portal, website, etc.

In step 404, the user (e.g., the user computing device 102A) generates a verification request including at least the machine-readable code as read from the physical asset and transmits the verification request to the processing server 106 in step 406. The verification request can be sent directly to the processing server 106 or via the computing device 104, e.g., a merchant interface in communication with the processing server 106.

In step 408, the processing server 106 receives the verification request and in step 410, the processing server 106 generates a query to identify a product identifier of a digital asset, e.g., included in an NFT stored on the blockchain, that matches or corresponds to the machine-readable code of the verification request. In step 412, the processing server 106 transmits the query to the blockchain network 112, e.g., a blockchain network node 114.

In step 414, the blockchain network 112 receives the query from the processing server 106 and generates a query response in step 416, which is then transmitted to the processing server 106 in step 418. The query response will identify whether or not a blockchain data value exists on the blockchain that corresponds to the machine-readable code included in the query.

In step 420, the processing server 106 receives the query response from the blockchain network 112. Based on the query response, the processing server 106 identifies a digital asset, e.g., an NFT, stored on the blockchain that corresponds to the machine-readable code in step 422.

In step 424, the processing server 106 generates a verification result indicating whether or not a digital asset has been identified. If a digital asset has been identified, the verification result will indicate the machine-readable code is valid and if a digital asset has not been identified, the verification result will indicate that no digital asset is stored on the blockchain and thus the machine-readable code is invalid. In step 426, the processing server 106 transmits the verification result to the user, e.g., via the computing device 104 or directly to the user computing device 102A. If the processing server 106 transmits the verification result to the computing device 104, the computing device 104 receives the verification result in step 428 and the computing device 104 presents the verification result to the user, e.g., via an interface on the user computing device 102A. If the processing server 106 transmits the verification result to the user computing device 102A, the user computing device 102A receives the verification result in step 430, e.g., via an interface of the computing device 104 and/or the processing server 106.

In step 432, the user, e.g., the user computing device 102A, generates payment data to purchase the physical asset from a merchant, e.g., the computing device 104. The payment data may include a user payment account number, a transaction amount, and any data relating to the physical product. In step 434, the user, e.g., the user computing device 102A, transmits the payment data to the merchant, e.g., the computing device 104.

In step 436, the merchant, e.g., the computing device 104, receives the payment data and processes the payment in step 438. The merchant, e.g., the computing device 104, may process the payment using traditional payment rails, e.g., via the payment network 108, via one or more cryptocurrency networks, e.g., the blockchain network 112, or any other suitable payment processing method/protocol.

Once the payment for the physical asset has been completed, in step 440, the merchant, e.g., the computing device 104, generates a transfer request message to transfer ownership of the digital asset that corresponds to the purchased physical asset from the merchant, e.g., the computing device 104, to the user, e.g., the user computing device 102A. The transfer request message can include transaction data such as a merchant identifier, e.g., an identifier associated with the computing device 104, a user identifier, e.g., an identifier associated with the user computing device 102A, a physical asset identifier, e.g., an identifier associated with the purchased physical asset, and/or a digital asset identifier, e.g., an identifier associated with the digital asset that corresponds to the purchased physical asset. In step 442, the merchant, e.g., the computing device 104, transmits the transfer request message to the processing server 106.

In step 444, the processing server 106 receives the transfer request message from the merchant, e.g., the computing device 104. In step 446, the processing server identifies a user profile, e.g., a user profile 208, stored in a database, e.g., the database 206, that includes the user identifier included in the transfer request message. For example, the processing server 106 can identify a user profile 208 associated with one, or both of, the user, e.g., the user computing device 102A, and the merchant, e.g., the computing device 104.

In step 448, the processing server 106 generates a blockchain transaction including at least the blockchain wallet address of the identified user account profile, e.g., the user computing device 102A, as the recipient address and the transaction data including at least the product identifier matching the machine-readable code of the purchased physical asset. In step 450, the processing server transmits the blockchain transaction to the blockchain network 112 for validation.

In step 452, the blockchain network 112, e.g., via the blockchain network node 114, receives the blockchain transaction and confirms the blockchain transaction to add the blockchain transaction to the blockchain of the blockchain network 112. The confirmation and addition of the blockchain transaction to the blockchain of the blockchain network 112 results in the digital asset being transferred from the blockchain wallet of the merchant, e.g., the computing device 104, to the blockchain wallet of the user, e.g., the user computing device 102A. Thus, the user, e.g., the user computing device 102A at the end of process 400 has ownership of both the physical asset and the corresponding digital asset, e.g., the NFT.

If the user, e.g., the user computing device 102A wants to re-sell the physical asset on a marketplace, e.g., a marketplace hosted by the computing device 104 and/or the processing server 106, the seller, e.g., the user computing device 102A, follows steps 402-430 of FIG. 4A to verify the authenticity of the physical asset. The process 400 then proceeds from step 430 to step 454 where the seller, e.g., the user computing device 102A, generates a product listing request. The product listing request includes at least the machine-readable code and a user identifier identifying the seller, e.g., the user computing device 102A. In embodiments, the product listing request can include physical asset information as discussed above with reference wot FIG. 1. In step 456, the seller, e.g., the user computing device 102A, transmits the product listing request to the computing device 104 and/or the processing server 106, which receives the product listing request in step 458.

In step 460, the processing server 106 generates a product listing for the physical asset associated with received machine-readable code, the product listing including the physical asset information included in the product listing request. In embodiment, generating the product listing request can include, identifying, by the processing server 106, a digital asset stored on the blockchain, e.g., the blockchain network 112, corresponding to the machine-readable code of the product listing request and the product listing can include the metadata of the digital asset associated the physical asset.

In step 462, the processing server 106 generates a confirmation message confirming the product listing has been created and transmits the confirmation message to the seller, e.g., the user computing device 102A, in step 464. While steps 458-465 are described as being performed by the processing server 106, steps 458-464 can also be performed by the computing device 104 or any other computing device hosting a marketplace for the sale of physical asset having associated digital assets stored in the blockchain network 112.

In step 466, the seller, e.g., the user computing device 102A, receives the confirmation message.

### Process for Cross-Network Transactions

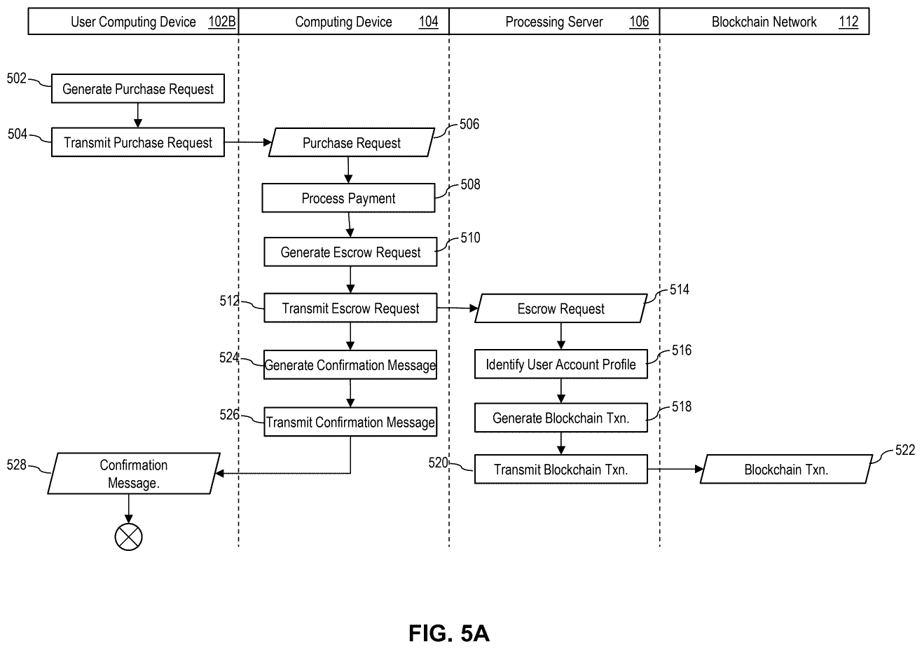

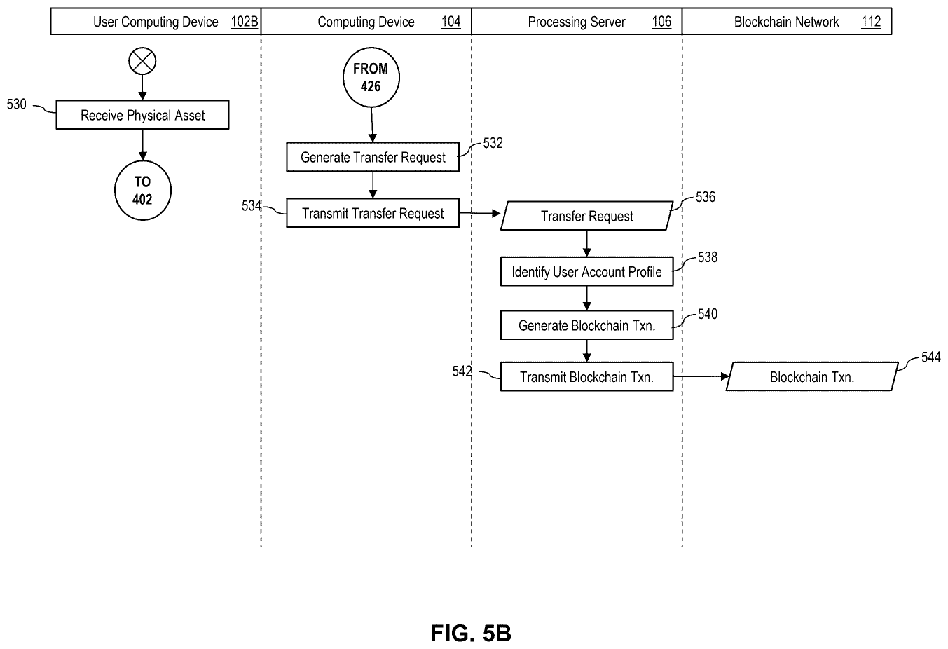

FIGS. 5A-5B illustrate process 400 for cross-network transactions via the system 100 of FIG. 1. More particularly, FIGS. 5A-5B illustrate a process for a second user purchasing a physical asset listed on a marketplace in the system 100.

In step 502, a second user, e.g., the user computing device 102B, generates a purchase request for a physical asset listed on the marketplace. The purchase request includes payment data to purchase the physical asset from the first user, e.g., the user computing device 102A via the marketplace. The payment data may include a second user payment account number, a transaction amount, and any data relating to the physical product. In step 504, the second user, e.g., the user computing device 102B, transmits the purchase request to the marketplace, e.g., the computing device 104 and/or the processing server 106.

In step 506, the marketplace, e.g., the computing device 104 and/or the processing server 106, receives the purchase request and processes the payment in step 508. The marketplace, e.g., the computing device 104 and/or the processing server 106, may process the payment using traditional payment rails, e.g., via the payment network 108, via one or more cryptocurrency networks, e.g., the blockchain network 112, or any other suitable payment processing method/protocol. In the process 500, the payment may be held, e.g., in an escrow account, until the second user, e.g., the user computing device 102B, verifies receipt of the physical asset.

Once the payment for the physical asset has been completed, in step 510, the marketplace, e.g., the computing device 104 and/or the processing server 106, generates an escrow request message to transfer ownership of the digital asset that corresponds to the purchased physical asset from the first user, e.g., the user computing device 102A, to an escrow account. The escrow request message can include transaction data such as a first user identifier, e.g., an identifier associated with the first user computing device 102A, a second user identifier, e.g., an identifier associated with the user computing device 102B, a physical asset identifier, e.g., an identifier associated with the purchased physical asset, and/or a digital asset identifier, e.g., an identifier associated with the digital asset that corresponds to the purchased physical asset. In step 512, the marketplace, e.g., the computing device 104 and/or the processing server 106, transmits the escrow request to the processing server 106.

In step 514, the processing server 106 receives the escrow request from the marketplace, e.g., the computing device 104 and/or the processing server 106. In step 516, the processing server 106 identifies a user profile, e.g., a user profile 208, stored in a database, e.g., the database 206, that includes the user identifier included in the transfer request message. For example, the processing server 106 can identify a user profile 208 associated with one, or both of, the first user, e.g., the user computing device 102A, and the second user, e.g., the user computing device 102B.

In step 518, the processing server 106 generates a blockchain transaction including at least the blockchain wallet address of the identified user account profile, e.g., the user computing device 102B, as the sending address and an escrow account as the recipient address and the transaction data including at least the product identifier matching the machine-readable code of the purchased physical asset. In step 520, the processing server transmits the blockchain transaction to the blockchain network 112 for validation.

In step 522, the blockchain network 112, e.g., via the blockchain network node 114, receives the blockchain transaction and confirms the blockchain transaction to add the blockchain transaction to the blockchain of the blockchain network 112. The confirmation and addition of the blockchain transaction to the blockchain of the blockchain network 112 results in the digital asset being transferred from the blockchain wallet of the first user, e.g., the user computing device 102A, to the escrow account.

Returning to step 512, the process 500 also proceeds to step 524 where the marketplace, e.g., the computing device 104 and/or the processing server 106, generates a confirmation message confirming the digital asset has been transferred to the escrow account. In step 526, the marketplace, e.g., the computing device 104 and/or the processing server 106, transmits the confirmation message to the second user, e.g., the user computing device 102B. In embodiments, the marketplace, e.g., the computing device 104 and/or the processing server 106, may also transmit the confirmation message to the first user, e.g., the user computing device 102A.

In step 528, the second user, e.g., the user computing device 102B, receives the confirmation message. The confirmation message may include user data such as the user data included in the user profiles of both the first user, e.g., the user computing device 102A, and the second user, e.g., the user computing device 102B.

In step 530, the second user, e.g., the user computing device, receives physical assets. For example, in response to the confirmation message the first user may ship the physical asset to the second user.

The process 500 proceeds from step 530 to step 402 and proceeds through step 426 with the second user, e.g., the user computing device 102B, replacing the first user, e.g., the user computing device 102A. From step 426, the process 500 proceeds to step 532.

In step 532, the marketplace, e.g., the computing device 104 and/or the processing server 106, generates a transfer request to transfer ownership of the digital asset that corresponds to the purchased physical asset from the escrow account to the second user, e.g., the user computing device 102B. The transfer request message can include transaction data such as a second user identifier, e.g., an identifier associated with the user computing device 102B, a user identifier, e.g., an identifier associated with the user computing device 102A, a physical asset identifier, e.g., an identifier associated with the purchased physical asset, and/or a digital asset identifier, e.g., an identifier associated with the digital asset that corresponds to the purchased physical asset. In step 534, the marketplace, e.g., the computing device 104 and/or the processing server 106, transmits the transfer request message to the processing server 106.

In step 536, the processing server 106 receives the transfer request message from the marketplace, e.g., the computing device 104 and/or the processing server 106. In step 538, the processing server identifies a user profile, e.g., a user profile 208, stored in a database, e.g., the database 206, that includes the user identifier included in the transfer request message. For example, the processing server 106 can identify a user profile 208 associated with one, or both of, the user, e.g., the second user computing device 102B, and the first user, e.g., the user computing device 102A.

In step 540, the processing server 106 generates a blockchain transaction including at least the blockchain wallet address of the identified second user account profile, e.g., the user computing device 102B, as the recipient address, the escrow account as the sending address, and the transaction data including at least the product identifier matching the machine-readable code of the purchased physical asset. In step 542, the processing server 106 transmits the blockchain transaction to the blockchain network 112 for validation.

In step 544, the blockchain network 112, e.g., via the blockchain network node 114, receives the blockchain transaction and confirms the blockchain transaction to add the blockchain transaction to the blockchain of the blockchain network 112. The confirmation and addition of the blockchain transaction to the blockchain of the blockchain network 112 results in the digital asset being transferred from the escrow account to the blockchain wallet of the second user, e.g., the user computing device 102B. Thus, the second user, e.g., the user computing device 102B at the end of process 500 has ownership of both the physical asset and the corresponding digital asset, e.g., the NFT.

### Exemplary Method for Cross-Network Transactions

FIGS. 6A-6D illustrate method 600 for cross-network transactions in the system 100 of FIG. 1.

In step 602, storing, in a memory (e.g., the memory 214) of a processing server (e.g., the processing server 106), a blockchain comprised of a plurality of blocks, each block of the plurality of blocks including at least a block header and one or more data values, wherein each data value of the one or more data values is a non-fungible token (NFT) associated with a physical product, and wherein each NFT includes metadata including at least a product identifier and product details.

In step 604, storing, in the memory (e.g., the memory 214) of the processing server (e.g., the processing server 106), a database (e.g., the database 206), the database including one or more user account profiles, each of the one or more user account profiles including a user identifier and a blockchain wallet address. The one or more user account profiles can include a tokenized payment card associated with the user.

In step 606, receiving, by a receiving device (e.g., the receiving device 202) of the processing server (e.g., the processing server 106) from a first user computing device (e.g., the user computing device 102A), a product verification request message including a machine-readable code. The machine-readable code can be a near-field communication chip attached to a product.

In step 608, executing, by a querying module (e.g., the querying module 216) of a processing server (e.g., the processing server 106), a query on the blockchain to identify an NFT including a product identifier matching the machine-readable code.

In step 610, in response to identifying an NFT including a product identifier matching the machine-readable code, determining, by a validation module (e.g., the validation module 220) of the processing server (e.g., the processing server 106), the product associated with the machine-readable code is verified.

In step 612, generating, by a generation module (e.g., the generation module 218) of the processing server (e.g., the processing server 106), a verification result indicating that the product associated with the machine-readable code is verified, the verification result including the product identifier and product details.

In step 614, transmitting, by a transmitting device (e.g., the transmitting device 222) of the processing server (e.g., the processing server 106), the verification results to the first user computing device (e.g., the user computing device 102A).

In step 616, receiving, by the receiving device (e.g., the receiving device 202) of the processing server (e.g., the processing server 106) from a merchant computing device (e.g., the computing device 104), a transfer request message including transaction data, the transaction data including a user identifier and the product identifier matching the machine-readable code.

In step 618, identifying, by the querying module (e.g., the querying module 216) of the processing server (e.g., the processing server 106), a user account profile of the one or more user account profiles including the user identifier of the transaction message.

In step 620, generating, by a generation module (e.g., the generation module 218) of the processing server (e.g., the processing server 106), a first blockchain transaction including the blockchain wallet address of the identified user account profile as the recipient address and the transaction data.

In step 622, transmitting, by the transmitting device (e.g., the transmitting device 222) of the processing server (e.g., the processing server 106), the first blockchain transaction to the blockchain.

In step 624, hosting, by the processing server (e.g., the processing server 106), a digital marketplace for the exchange of products and NFTs associated with the products.

In step 626, receiving, by the receiving device (e.g., the receiving device 202) of the processing server (e.g., the processing server 106) from the first user computing device (e.g., the user computing device 102A), a product listing request including at least the machine-readable code and a user identifier identifying the first user.

In step 628, executing, by the querying module (e.g., the querying module 216) of the processing server (e.g., the processing server 106), a query on the blockchain to identify an NFT including a product identifier matching the machine-readable code of the product listing request.

In step 630, receiving, by the receiving device of the processing server (e.g., the processing server 106), a product result including metadata of the NFT including the product identifier matching the machine-readable code.

In step 632, generating, by the generation module (e.g., the generation module 218) of the processing server (e.g., the processing server 106), a product listing for a product associated received NFT, the product listing including the metadata of the received NFT and the first user identifier included in the product listing request.

In step 634, listing, by the processing server (e.g., the processing server 106), the product listing on the digital marketplace.

In step 636, receiving, by the receiving device (e.g., the receiving device 202) of the processing server (e.g., the processing server 106) from a second user computing device (e.g., the user computing device 102B), a product purchase request, the product purchase request including at least the product identifier included in the product listing, the user identifier included in the product listing, a user identifier of the second user, and a transaction amount.

In step 638, identifying, by the querying module (e.g., the querying module 216) of the processing server (e.g., the processing server 106), a user account profile of the one or more user account profiles including the user identifier of the second user included in the product purchase request.

In step 640, generating, by the generation module (e.g., the generation module 218) of the processing server (e.g., the processing server 106), a second blockchain transaction including the blockchain wallet address of the identified user account profile of the second user as the sending address, a blockchain wallet address of an escrow account as the recipient address, the identified user account including the user identifier included in the product listing, and the transaction amount.

In step 642, transmitting, by the transmitting device (e.g., the transmitting device 222) of the processing server (e.g., the processing server 106), the second blockchain transaction to the blockchain.

In step 644, receiving, by the receiving device (e.g., the receiving device 202) of the processing server (e.g., the processing server 106) from the second user computing device (e.g., the user computing device 102B), a second product verification request message including a second machine-readable code.

In step 646, executing, by the querying module (e.g., the querying module 216) of a processing server (e.g., the processing server 106), a query on the blockchain to identify an NFT including a product identifier matching the second machine-readable code.

In step 648, receiving, by the receiving device (e.g., the receiving device 202) of the processing server (e.g., the processing server 106), a verification result including metadata of the NFT including the product identifier matching the second machine-readable code.

In step 650, transmitting, by a transmitting device (e.g., the transmitting device 222) of the processing server (e.g., the processing server 106), the verification results to the second user computing device (e.g., the user computing device 102B).

In step 652, generating, by the generation module (e.g., the generation module 218) of the processing server (e.g., the processing server 106), a third blockchain transaction including the blockchain wallet address of the of the escrow account as the sending address, a blockchain wallet address of the identified user account including the user identifier included in the product listing as the recipient address, and the transaction amount.

In step 654, transmitting, by the transmitting device (e.g., the transmitting device 222) of the processing server (e.g., the processing server 106), the third blockchain transaction to the blockchain.

### Computer System Architecture

FIG. 7 illustrates computer system 700 in which embodiments of the present disclosure, or portions thereof, can be implemented as computer-readable code. For example, the user computing devices 102, the computing device 104, the processing server 106, the payment network nodes 110, and/or the blockchain network nodes 114 can be implemented in the computer system 700 using hardware, non-transitory computer readable media having instructions stored thereon, or a combination thereof and can be implemented in one or more computer systems or other processing systems. Hardware can embody modules and components used to implement the processes and methods of FIGS. 3A-6D.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above-described embodiments.

A processor unit or device as discussed herein can be a single processor, a plurality of processors, or combinations thereof. Processor devices can have one or more processor “cores. ” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 704 can be a special purpose or a general-purpose processor device specifically configured to perform the functions discussed herein. The processor device 704 can be connected to a communications infrastructure 706, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to people having skill in the relevant art. The computer system 700 can also include a main memory 708 (e.g., random access memory, read-only memory, etc.), and can also include a secondary memory 710. The secondary memory 710 can include the hard disk drive 712 and a removable storage drive 714, such as a floppy disk drive, a magnetic tape drive, an optical disk drive, a flash memory, etc.

The removable storage drive 714 can read from and/or write to the removable storage unit 718 in a well-known manner. The removable storage unit 718 can include a removable storage media that can be read by and written to by the removable storage drive 714. For example, if the removable storage drive 714 is a floppy disk drive or universal serial bus port, the removable storage unit 718 can be a floppy disk or portable flash drive, respectively. In one embodiment, the removable storage unit 718 can be non-transitory computer readable recording media.

In some embodiments, the secondary memory 710 can include alternative means for allowing computer programs or other instructions to be loaded into the computer system 700, for example, the removable storage unit 722 and an interface 720. Examples of such means can include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to people having skill in the relevant art.

The computer system 700 can also include a communications interface 724. The communications interface 724 can be configured to allow software and data to be transferred between the computer system 700 and external devices. Exemplary communications interfaces 724 can include a modem, a network interface (e.g., an Ethernet card), a communications port, a PCMCIA slot and card, etc. Software and data transferred via the communications interface 724 can be in the form of signals, which can be electronic, electromagnetic, optical, or other signals as will be apparent to persons having skill in the relevant art. The signals can travel via a communications path 726, which can be configured to carry the signals and can be implemented using wire, cable, fiber optics, a phone line, a cellular phone link, a radio frequency link, etc.

The computer system 700 can further include a display interface 702. The display interface 702 can be configured to allow data to be transferred between the computer system 700 and external display 730. Exemplary display interfaces 702 can include high-definition multimedia interface (HDMI), digital visual interface (DVI), video graphics array (VGA), etc. The display 730 can be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 708 and secondary memory 710, which can be memory semiconductors (e.g., DRAMs, etc.). These computer program products can be a means of providing software for the computer system 700. Computer programs (e.g., computer control logic) can be stored in the main memory 708 and/or the secondary memory 710. Computer programs can also be received via the communications interface 724. Such computer programs, when executed, can enable computer system 700 to implement the present methods as discussed herein. In particular, the computer programs, when executed, can enable processor device 7 to implement the processes and methods illustrated by FIGS. 3A-6D, as discussed herein. Accordingly, such computer programs can represent controllers of the computer system 700. Where the present disclosure is implemented using software, the software can be stored in a computer program product and loaded into the computer system 700 using the removable storage drive 714, interface 720, and hard disk drive 712, or communications interface 724.

The processor device 704 can comprise one or more modules or engines configured to perform the functions of the computer system 700. Each of the modules or engines can be implemented using hardware and, in some instances, can also utilize software, such as corresponding to program code and/or programs stored in the main memory 708 or secondary memory 710. In such instances, program code can be compiled by the processor device 904 (e.g., by a compiling module or engine) prior to execution by the hardware of the computer system 700. For example, the program code can be source code written in a programming language that is translated into a lower-level language, such as assembly language or machine code, for execution by the processor device 704 and/or any additional hardware components of the computer system 700. The process of compiling can include the use of lexical analysis, preprocessing, parsing, semantic analysis, syntax-directed translation, code generation, code optimization, and any other techniques that can be suitable for translation of program code into a lower-level language suitable for controlling the computer system 700 to perform the functions disclosed herein. It will be apparent to people having skill in the relevant art that such processes result in the computer system 700 being a specially configured computer system 700 uniquely programmed to perform the functions discussed above.

Techniques consistent with the present disclosure provide, among other features, systems and methods for account type registration for blockchain wallets. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for cross-network transactions, comprising:
storing, in a memory of a processing server, a blockchain comprised of a plurality of blocks, each block of the plurality of blocks including at least a block header and one or more data values, wherein each data value of the one or more data values is a non-fungible token (NFT) associated with a physical asset, and wherein each NFT includes metadata including at least a product identifier and product details;
storing, in the memory of the processing server, a database, the database including one or more user account profiles, each of the one or more user account profiles including a user identifier and a blockchain wallet address;
receiving, by a receiving device of the processing server from a first user computing device, a product verification request message including a machine-readable code;
executing, by a querying module of a processing server, a query on the blockchain to identify an NFT including a product identifier matching the machine-readable code;
in response to identifying an NFT including a product identifier matching the machine-readable code, determining, by a validation module of the processing server, the product associated with the machine-readable code is verified;
generating, by a generation module of the processing server, a verification result indicating that the product associated with the machine-readable code is verified, the verification result including the product identifier and product details; and
transmitting, by a transmitting device of the processing server, the verification result to the first user computing device.

2. The method of claim 1, further comprising:
receiving, by the receiving device of the processing server from a merchant computing device, a transfer request message including transaction data, the transaction data including a user identifier and the product identifier matching the machine-readable code;
identifying, by the querying module of the processing server, a user account profile of the one or more user account profiles including the user identifier of the transaction message;
generating, by a generation module of the processing server, a first blockchain transaction including the blockchain wallet address of the identified user account profile as a recipient address and the transaction data; and
transmitting, by the transmitting device of the processing server, the first blockchain transaction to the blockchain.

3. The method of claim 2, further comprising:
hosting, by the processing server, a digital marketplace for exchange of products and NFTs associated with the products;
receiving, by the receiving device of the processing server from the first user computing device, a product listing request including at least the machine-readable code and a user identifier identifying the first user;
executing, by the querying module of the processing server, a query on the blockchain to identify an NFT including a product identifier matching the machine-readable code of the product listing request;
receiving, by the receiving device of the processing server, a product result including metadata of the NFT including the product identifier matching the machine-readable code;
generating, by the generation module of the processing server, a product listing for a product associated received NFT, the product listing including the metadata of the received NFT and the first user identifier included in the product listing request; and
listing, by the processing server, the product listing on the digital marketplace.

4. The method of claim 3, further comprising:
receiving, by the receiving device of the processing server from a second user computing device, a product purchase request, the product purchase request including at least the product identifier included in the product listing, the user identifier included in the product listing, a user identifier of the second user, and a transaction amount;
identifying, by the querying module of the processing server, a user account profile of the one or more user account profiles including the user identifier of the second user included in the product purchase request;
identifying, by the querying module of the processing server, a user account profile of the one or more user account profiles including the user identifier included in the product listing;
generating, by the generation module of the processing server, a second blockchain transaction including the blockchain wallet address of the identified user account profile of the second user as a sending address, a blockchain wallet address of an escrow account as a recipient address, the identified user account including the user identifier included in the product listing, and the transaction amount; and
transmitting, by the transmitting device of the processing server, the second blockchain transaction to the blockchain.

5. The method of claim 4, further comprising:
receiving, by the receiving device of the processing server from the second user computing device, a second product verification request message including a second machine-readable code;
executing, by the querying module of a processing server, a query on the blockchain to identify an NFT including a product identifier matching the second machine-readable code;
receiving, by the receiving device of the processing server, a verification result including metadata of the NFT including the product identifier matching the second machine-readable code;
transmitting, by a transmitting device of the processing server, the verification result to the second user computing device;
generating, by the generation module of the processing server, a third blockchain transaction including the blockchain wallet address of the of the escrow account as the sending address, a blockchain wallet address of the identified user account including the user identifier included in the product listing as the recipient address, and the transaction amount; and
transmitting, by the transmitting device of the processing server, the third blockchain transaction to the blockchain.

6. The method of claim 1, wherein the machine-readable code is a near-field communication chip attached to a product.

7. The method of claim 1, wherein the one or more user account profiles includes a tokenized payment card.

8. The method of claim 1, wherein the determining the product associated with the machine-readable code is verified and the generating the verification result is executed by a smart contract on the blockchain.

9. The method of claim 4, wherein the blockchain wallet address included in each of the one or more user account profiles is a tokenized payment card;
wherein the identified user account profile of the second user includes a first preferred transaction currency and the identified user account profile of the user identifier included in the product listing includes a second preferred transaction currency; and
wherein the generating the second blockchain transaction includes:
converting, by the processing server, the transaction amount from the first preferred transaction currency to the second preferred transaction currency.

10. A system for cross-network transactions, comprising:
a first user computing device; and
a processing server, the processing server configured to:
store, in a memory of the processing server, a database, the database including one or more user account profiles, each of the one or more user account profiles including a user identifier and a blockchain wallet address;
receive, by a receiving device of the processing server from a first user computing device, a product verification request message including a machine-readable code;
execute, by a querying module of a processing server, a query on the blockchain to identify an NFT including a product identifier matching the machine-readable code;
in response to identifying an NFT including a product identifier matching the machine-readable code, determine, by a validation module of the processing server, the product associated with the machine-readable code is verified;
generate, by a generation module of the processing server, a verification result indicating that the product associated with the machine-readable code is verified, the verification result including the product identifier and product details; and
transmit, by a transmitting device of the processing server, the verification result to the first user computing device.

11. The system of claim 10, wherein the system includes a merchant computing device; and
the processing server is further configured to:
receive, by the receiving device of the processing server from a merchant computing device, a transfer request message including transaction data, the transaction data including a user identifier and the product identifier matching the machine-readable code;
identify, by the querying module of the processing server, a user account profile of the one or more user account profiles including the user identifier of the transaction message;
generate, by a generation module of the processing server, a first blockchain transaction including the blockchain wallet address of the identified user account profile as a recipient address and the transaction data; and
transmit, by the transmitting device of the processing server, the first blockchain transaction to the blockchain.

12. The system of claim 10, wherein the processing server is further configured to:
host, by the processing server, a digital marketplace for exchange of products and NFTs associated with the products;
receive, by the receiving device of the processing server from the first user computing device, a product listing request including at least the machine-readable code and a user identifier identifying the first user;
execute, by the querying module of the processing server, a query on the blockchain to identify an NFT including a product identifier matching the machine-readable code of the product listing request;
receive, by the receiving device of the processing server, a product result including metadata of the NFT including the product identifier matching the machine-readable code;
generate, by the generation module of the processing server, a product listing for a product associated received NFT, the product listing including the metadata of the received NFT and the first user identifier included in the product listing request; and
list, by the processing server, the product listing on the digital marketplace.

13. The system of claim 10, wherein the system includes a second user computing device; and
the processing server is further configured to:
receive, by the receiving device of the processing server from a second user computing device, a product purchase request, the product purchase request including at least the product identifier included in the product listing, the user identifier included in the product listing, a user identifier of the second user, and a transaction amount;
identify, by the querying module of the processing server, a user account profile of the one or more user account profiles including the user identifier of the second user included in the product purchase request;
identify, by the querying module of the processing server, a user account profile of the one or more user account profiles including the user identifier included in the product listing;
generate, by the generation module of the processing server, a second blockchain transaction including the blockchain wallet address of the identified user account profile of the second user as a sending address, a blockchain wallet address of an escrow account as a recipient address, the identified user account including the user identifier included in the product listing, and the transaction amount; and
transmit, by the transmitting device of the processing server, the second blockchain transaction to the blockchain.

14. The system of claim 13, wherein the processing server is further configured to:
receive, by the receiving device of the processing server from the second user computing device, a second product verification request message including a second machine-readable code;
execute, by the querying module of a processing server, a query on the blockchain to identify an NFT including a product identifier matching the second machine-readable code;
receive, by the receiving device of the processing server, a verification result including metadata of the NFT including the product identifier matching the second machine-readable code;
transmit, by a transmitting device of the processing server, the verification result to the second user computing device;
generate, by the generation module of the processing server, a third blockchain transaction including the blockchain wallet address of the of the escrow account as the sending address, a blockchain wallet address of the identified user account including the user identifier included in the product listing as the recipient address, and the transaction amount; and
transmit, by the transmitting device of the processing server, the third blockchain transaction to the blockchain.

15. The system of claim 10, wherein the machine-readable code is a near-field communication chip attached to a product.

16. The system of claim 10, wherein the one or more user account profiles includes a tokenized payment card.

17. The system of claim 10, wherein the determining the product associated with the machine-readable code is verified and the generating the verification result is executed by a smart contract on the blockchain.

18. The system of claim 10, wherein the blockchain wallet address included in each of the one or more user account profiles is a tokenized payment card;
wherein the identified user account profile of the second user includes a first preferred transaction currency and the identified user account profile of the user identifier included in the product listing includes a second preferred transaction currency; and
wherein the generating the second blockchain transaction includes:
converting, by the processing server, the transaction amount from the first preferred transaction currency to the second preferred transaction currency.

19. A computer program product for cross-network transactions, the computer program product comprising:
a non-transitory computer-readable storage medium having program instructions embodied therewith, the program instructions executable by a computer to cause the computer to:
store, in a memory, a blockchain comprised of a plurality of blocks, each block of the plurality of blocks including at least a block header and one or more data values, wherein each data value of the one or more data values is a non-fungible token (NFT) associated with a physical asset, and wherein each NFT includes metadata including at least a product identifier and product details;
store, in the memory, a database, the database including one or more user account profiles, each of the one or more user account profiles including a user identifier and a blockchain wallet address;
receive, by a receiving device from a first user computing device, a product verification request message including a machine-readable code;
execute, by a querying module, a query on the blockchain to identify an NFT including a product identifier matching the machine-readable code;
in response to identify an NFT including a product identifier matching the machine-readable code, determine, by a validation module, the product associated with the machine-readable code is verified;
generate, by a generation module, a verification result indicating that the product associated with the machine-readable code is verified, the verification result including the product identifier and product details; and
transmit, by a transmitting device, the verification result to the first user computing device.

20. The computer program product of claim 19, further comprising program instructions executable by the computer to cause the computer to:
receive, by the receiving device from a merchant computing device, a transfer request message including transaction data, the transaction data including a user identifier and the product identifier matching the machine-readable code;
identify, by the querying module, a user account profile of the one or more user account profiles including the user identifier of the transaction message;
generate, by a generation module, a first blockchain transaction including the blockchain wallet address of the identified user account profile as a recipient address and the transaction data; and
transmit, by the transmitting device, the first blockchain transaction to the blockchain.
